(19) United States
(12) Patent Application Publication
(10) Pub. No.: US 2005/0089069 A1
(43) Pub. Date: Apr. 28, 2005

(54) Image forming apparatus and semiconductor laser modulation driving apparatus

(76) Inventors: Dan Ozasa, Kanagawa (JP); Masaaki Ishida, Kanagawa (JP); Yasuhiro Nihei, Kanagawa (JP); Atsufumi Omori, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/942,073

(22) Filed: Sep. 16, 2004

(30) Foreign Application Priority Data
Sep. 22, 2003 (JP) 2003-329595

(51) Int. Cl. H01S 3/10

(52) U.S. Cl. 372/26; 372/38.02

(57) ABSTRACT

A color image forming apparatus produces a latent image on a photosensitive body based on a signal output from a scanning light detecting part in response to detection of scanning light; a semiconductor laser modulation signal generating part includes a clock generating part and a clock modulation part; a semiconductor laser and a semiconductor laser driving part are provided for each color of yellow, magenta, cyan and black; and further, a plurality of the semiconductor lasers are provided for at least one color of yellow, magenta, cyan and black.

### BACKGROUND OF THE INVENTION

1. Field of the Invention

The present invention relates to a semiconductor laser (simply referred to as an ‘LD’, hereinafter) modulation signal generating circuit and an image forming apparatus, and, in particular, to an LD modulation signal generating circuit modulating light output of a light source in a laser printer, an optical disk apparatus, a digital copier, an optical communication apparatus or such, and a semiconductor laser modulating apparatus and an image forming apparatus modulating light output of the light source and forming an image in the laser printer, optical disk apparatus, digital copier, optical communication apparatus or such.

2. Description of the Related Art

In a laser printer, an optical disk apparatus, a digital copier, an optical communication apparatus or such, in order to modulate light output of a light source, an image data generating part, an LD modulation data generating part and an LD driver are provided. The image data generating part converts given data from a scanner or such into image data in consideration of y characteristics of a photosensitive body or such, for the purpose of obtaining data which is suitable to be processed by a laser printer or such. The LD modulation data generating part generates LD modulation data with which a semiconductor laser is modulated according to the image data in a power modulation manner or a pulse width modulation manner. The LD driver drives the LD in response to the LD modulating data.

In the related art, as shown in FIG. 48, the image data generating part is configured in a form of a PCB/ASIC (PCB1/ASIC1) while the LD modulation data generating part and the LD driving part are configured in another PCB/ASIC (PCB2/ASIC2), separately. This is because, in comparison between a data transfer rate of image data and a data transfer rate of LD modulation data, the data transfer rate of the LD modulation data is higher, and therefore, the LD modulation data generating part and the LD driving part are preferably disposed closely as much as possible.

Japanese Patent No. 3283256 discloses this manner, for example, and discloses an image forming apparatus in which a pulse width modulation circuit, a recording device and a driving circuit are configured in a form of a single circuit substrate, a digital image control circuit is provided separately from this single circuit substrate, and a digital image signal supplied to the pulse width modulation circuit is transmitted in a manner of differential transmission.

Further, in a scanning optical system as shown in FIG. 8, a variation in a distance between a deflection reflective surface of a deflector such as a polygon scanner (polygon mirror) from a rotational axis may cause a fluctuation in a scanning velocity of a beam spot (scanning beam) with which a to-be-scanned surface is scanned. This fluctuation in the scanning velocity causes a shimmering in a formed image and may result in image quality deterioration. Accordingly, in order to solve this problem, it is necessary to carry out appropriate correction of the scanning velocity fluctuation.

Furthermore, in a case of a multi-beam optical system having a plurality of light sources, when a difference exists in excitation wavelengths among the respective light sources, a deviation occurs in exposure positions with an optical system in which no correction is made for color aberration for a scanning lens. Thereby, a difference may occur in scanning widths among the light sources as a result of spots from the respective light sources being applied to scan a to-be-scanned surface. This may result in deterioration in image quality. In order to solve this problem, it is necessary to carry out correction for the scanning widths. It is noted that occurrence of scanning fluctuation in the optical system may depend on a particular position along a scanning line according to optical characteristics of the optical system.

In the related art, in order to carry out the correction for the scanning fluctuation or such, as disclosed by Japanese Laid-open Patent Applications Nos. 11-167081 and 2001-228415, for example, a frequency of a pixel clock signal is changed basically, and thereby, positional control for a beam spot along a scanning line is carried out.

As another technology, as shown in FIG. 49, a scanning velocity is detected as a result of the number of clock pulses between photodetectors A and B (908 and 909) disposed at both ends of a photosensitive body 905 being counted, and thereby, a rotational speed of a polygon mirror 1104 is controlled. As a further another technology, for example, in a configuration shown in FIG. 49, a time interval between the two detection signals is counted with high frequency clock pulses, and, based on the counting information, a phase of a writing clock signal is shifted, whereby a position of a beam spot is controlled (see Japanese Laid-open Patent Application No. 2002-36626 filed by the applicant of the present application).

### SUMMARY OF THE INVENTION

Along with recent increase in an operation speed of an image forming apparatus, the number of LDs to drive increases, and, a plurality of (two, four, or, in some case, eight) LDs or an LD array may be used for a single color component. Further, as a color copier or a color printer has been developed, a plurality of LD modulation signal generating parts and a plurality of LD driving parts are required in the apparatus. For example, in a case where a color image is formed with four color components with two LDs by image data of four bits and with an LD modulation signal of one bit, total 64 bits of image data and eight bits of LD modulation signals are required. In an example of a configuration in the related art shown in FIG. 48, it is necessary to transmit 64 lines of signals at a high speed even through it is not higher than the LD modulation signal. However, in such a configuration, since the number of signal lines required is large, a configuration required for the signal transfer becomes complicated, and a high speed signal transfer may be actually difficult.

Furthermore, as increase in a circuit density in a device is required as well as high sped operation is required therein, a power source voltage is further reduced. On the other hand, in order to achieve a high resolution image with an optical disk or a copier/printer, a wavelength of a semiconductor laser (LD) is shortened. As the wavelength in the LD is shortened, a drop voltage in the LD (voltage between both ends thereof) increases. In other words, a voltage required to drive the LD increases. Thus, as to power source voltage, requirements contradict between generation of the high frequency modulation signal and driving the LD.

An object of the present invention is to provide a color image forming apparatus, a semiconductor laser modulation driving apparatus and an image forming apparatus in which an LD driving part and an LD modulation signal generating part are separated, a power source voltage necessary is supplied to the LD driving part while a high-speed modulation signal is generated in the LD modulation signal generating part, and thereby, it becomes possible to select a device in a high circuit density using a low power source voltage for the LD modulation signal generating circuit while a high driving voltage is supplied to the LD driving part wherein the LD modulation signal is transferred therebetween.

According to the present invention, as shown in FIG. 3, an image data generating part and an LD modulation signal generating part are configured in a common single substrate (PCB) or in a common single ASIC, an LD driving part is disposed closely wit an LD, and image data signals are transferred at a high speed in parallel within the common single PCB or ASIC. As the LD driving part is disposed closely to the LD, high speed driving performance in the LD is improved. In such a configuration, for example, it is necessary to transfer a pulse width modulation signal as the LD modulation signal to the LD driving part. According to the present invention, by configuring the LD modulation signal in a reduced amplitude differential signal, it is possible to achieve increase in operation speed, improvement of EMI characteristics, improvement of noise protection performance, and a high definition in the LD modulation signal. Further, as the LD driving part and the LD modulation signal generating part are separated, a power source voltage necessary is supplied to the LD driving part while a high-speed modulation signal is generated by the LD modulation signal generating part. Thereby, it is possible to select a device of a lower power source voltage for the LD modulation signal generating part while a necessary driving voltage can be provided for the purpose of driving the LD where the LD modulation signal is transferred (transmitted) therebetween.

According to the present invention, the following advantages are expected.

(1) As a result of the LD modulation signal generating part being provided for each color component of yellow, magenta, cyan and black, it is possible to increase a writing speed for each color component. Also, for each color, a reference clock signal can be adjusted, and versatility is improved.

(2) As a result of providing the semiconductor laser (LD) driving part for all the color components, it is possible to miniaturize the semiconductor laser driving part.

(3.) As a result of providing the semiconductor laser (LD) modulation signal generating part for all the color components, it is possible to miniaturize the semiconductor laser modulation signal generating part.

(4) When providing the semiconductor laser driving part for each color component, it is advantageous to apply the present invention to a tandem type of image forming apparatus.

(5) As a result of a CML circuit being applied for data transfer between the semiconductor laser driving part and the semiconductor laser modulation signal generating part, high speed transfer is achieved therebetween. Also, it is possible to achieve improvement in EMI protection performance, noise protection performance, and a high definition in the LD modulation signal.

(6) Also, it is possible to apply a desired low swing output as output of the semiconductor laser modulation signal generating part. Also, high speed signal transmission is achieved.

(7) Further, it is possible to reduce swing of a signal input to a CML circuit, to reduce a fluctuation of a current source possibly occurring due to switching in the CML circuit, and thus to increase a switching speed therein.

(8) Since it is possible to obtain a low swing differential signal from a single LD modulation signal, it is possible to achieve data transfer at a high speed with a high definition.

(9) In a case where a resistor or a resistance in an integrated circuit is applied as a load of a CML circuit, a variation in output swing possibly occurring due to a variation of the resistor or resistance is reduced, and thus, it is possible to achieve output with precise swing.

(10) In a case where an external resistor or a resistance is applied as a load of a CML circuit, also a variation in output swing possibly occurring due to a variation in the resistor or resistance is reduced, and thus, it is possible to achieve output with precise swing.

(11) Also in a multi-beam image forming apparatus or a tandem type image forming apparatus, high speed data transfer is achieved.

### BRIEF DESCRIPTION OF THE DRAWINGS

Other objects and further features of the present invention will become more apparent from the following detailed description when read in conjunction with the accompanying drawings:

FIG. 1 shows a first configuration according to a first embodiment of the present invention;

FIG. 2 shows a second configuration according to the first embodiment of the present invention;

FIG. 3 shows a waveform in a case where an LD modulation signal is transferred in a digital manner;

FIGS. 4 and 5 show reduced amplitude modulation signals and inverted signals thereof;

FIG. 6 shows an example of a configuration according to an LVDS;

FIG. 7 shows a third configuration according to the first embodiment of the present invention;

FIG. 8 shows an example of a system in a case where the present invention is applied to a raster scanning type image forming apparatus;

FIG. 9 shows a fourth configuration according to the first embodiment of the present invention;

FIG. 10 shows a specific configuration example of a VLD generating part;

FIG. 11 shows a fifth configuration according to the first embodiment of the present invention;

FIG. 12 shows a detailed configuration of an ASIC1 shown in FIG. 11;

FIG. 13 shows a configuration of an image clock generating part (pixel clock generating apparatus);

FIG. 14 shows a configuration of an pixel clock generating circuit;

FIG. 15 shows a first configuration according to a second embodiment of the present invention;

FIG. 16 shows the second configuration according to the second embodiment of the present invention;

FIG. 17 shows a third configuration according to the second embodiment of the present invention;

FIG. 18 shows a fourth configuration according to the second embodiment of the present invention;

FIG. 19 shows a fifth configuration according to the second embodiment of the present invention;

FIG. 20 shows a sixth configuration according to the second embodiment of the present invention;

FIG. 21 shows a seventh configuration according to the second embodiment of the present invention;

FIG. 22 shows a eighth configuration according to the second embodiment of the present invention;

FIG. 23 shows a ninth configuration according to the second embodiment of the present invention;

FIG. 24 shows a tenth configuration according to the second embodiment of the present invention;

FIG. 25 shows an eleventh configuration according to the second embodiment of the present invention;

FIG. 26 shows a twelfth configuration according to the second embodiment of the present invention;

FIG. 27 shows a thirteenth configuration according to the second embodiment of the present invention;

FIG. 28 shows a fourteenth configuration according to the second embodiment of the present invention;

FIG. 29 shows a fifteenth configuration according to the second embodiment of the present invention;

FIG. 30 shows a sixteenth configuration according to the second embodiment of the present invention;

FIG. 31 shows a seventeenth configuration according to the second embodiment of the present invention;

FIG. 32 shows an eighteenth configuration according to the second embodiment of the present invention;

FIG. 33 shows a nineteenth configuration according to the second embodiment of the present invention;

FIG. 34 shows a twelfth configuration according to the second embodiment of the present invention;

FIG. 35 shows a twenty-first first configuration according to the second embodiment f the present invention;

FIG. 36 shows a twenty-second configuration according to the second embodiment of the present invention;

FIG. 37 shows a twenty-third configuration according to the second embodiment of the present invention;

FIG. 38 shows a configuration of a semiconductor laser modulation signal generating part and a semiconductor laser driving part in a tandem type color machine;

FIG. 39 shows a first configuration according to a third embodiment of the present invention;

FIG. 40 shows a second configuration according to the third embodiment of the present invention;

FIG. 41 shows a third configuration according to the third embodiment of the present invention;

FIG. 42 shows a fourth configuration according to the third embodiment of the present invention;

FIG. 43 shows a fifth configuration according to the third embodiment of the present invention;

FIG. 44 shows a multi-beam scanning apparatus according to a fourth embodiment of the present invention;

FIG. 45 shows a light source unit in a multi-beam scanning apparatus;

FIG. 46 shows another configuration example of the light source unit;

FIG. 47 shows an example in which the present invention is applied to a tandem type color machine;

FIG. 48 shows an example of a configuration in the related art; and

FIG. 49 shows another example in the related art.

### DETAILED DESCRIPTION OF THE PREFERRED EMBODIMENTS

With reference to figures, preferred embodiments of the present invention are described.

A first embodiment of the present invention is described.

FIG. 1 shows a first configuration according to the first embodiment of the present invention. As shown in FIG. 1, the configuration includes an image data generating part 1, an LD modulation data generating part 2. an LD driving part 3, and an LD 4. In this configuration, the image data generating part 1 and the LD modulation signal generating part 2 are configured in a common single substrate PCB1 or a common single ASIC1, while the LD driving part 3 is disposed closely to the LD 4. As the number of channels increases in LDs and color image forming is widely spread, the number of signals for image data further increases. In order to properly respond to such increase in the number of signal lines for image data, it is advantageous to provide the image data generating part 1 and the LD modulation data generating part 2 on a same substrate, or, to provide the functions thereof within a same ASIC, and thereby, a plurality of signals can be transmitted therebetween in parallel at a high speed. Further, by disposing the LD driving part 3 and the LD 4 or an LD array closely on a same substrate, high speed and stable operation can be carried out therein.

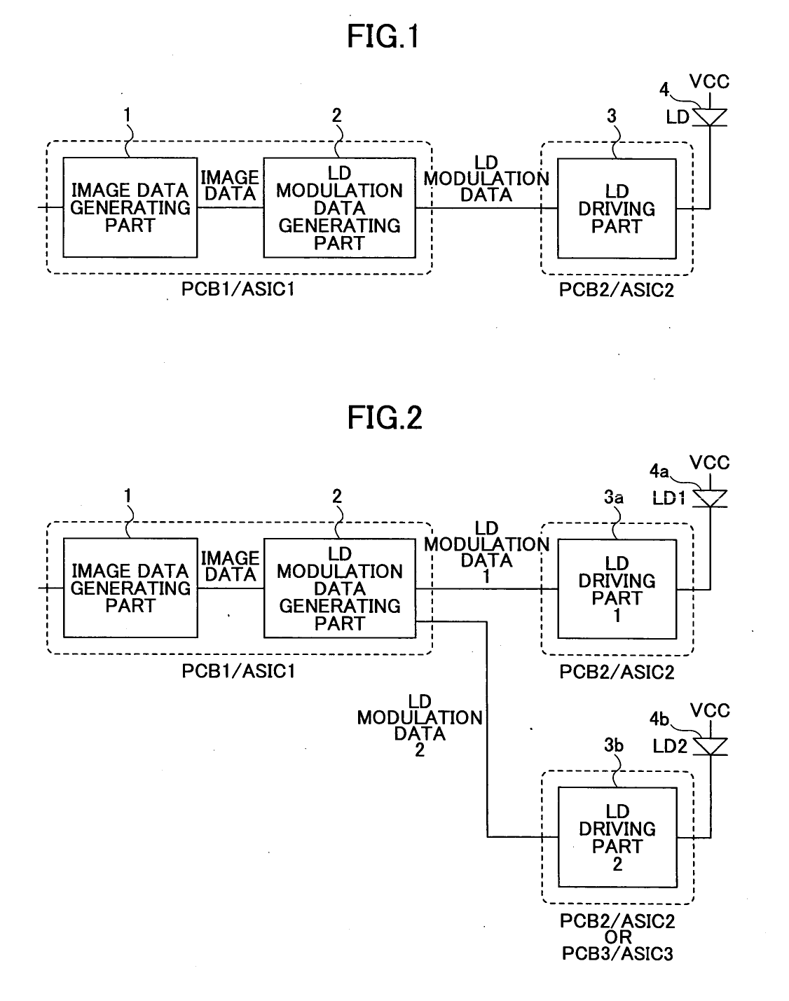

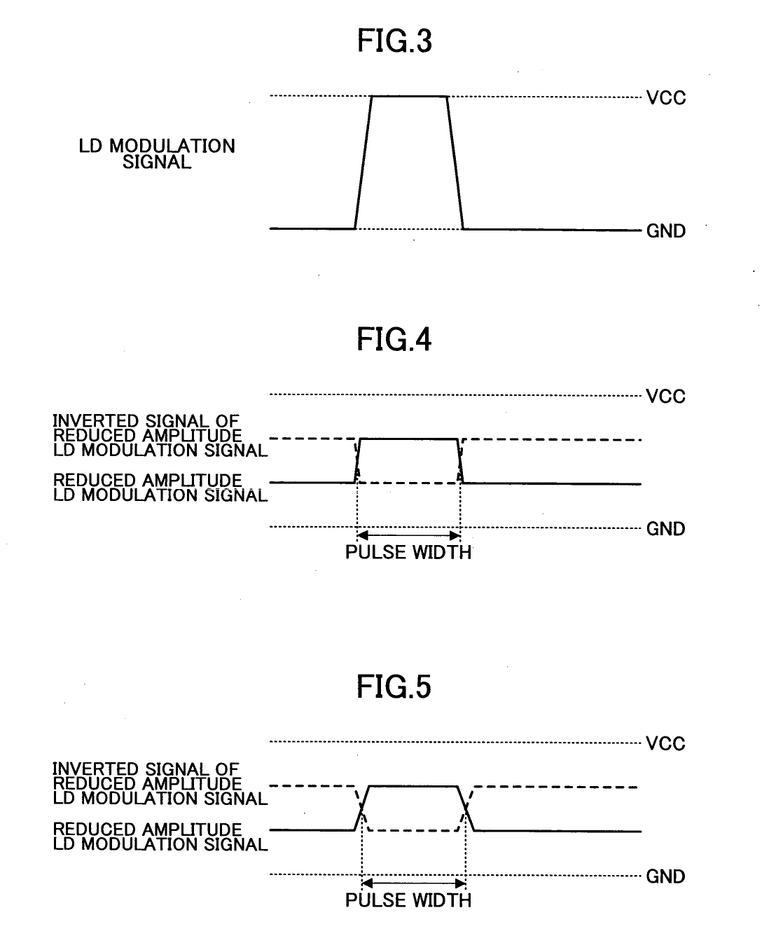

FIG. 2 shows a second configuration according to the first embodiment of the present invention. In this configuration, a plurality of chancels are provided. In this configuration, modulation signals for an LD 1 and an LD 2 are produced in a single LD modulation data generating part 2. As shown in FIG. 2, as the number of the LDs increases, the number of LD driving parts 3a, 3b as well as the number of LD modulation data transfer parts required to transfer LD modulation data 1 and LD modulation data 2 to the LD driving parts 1 and 2 (3a and 3b), respectively, increases. Further, lengths of signal lines (wires) laid therebetween increase. Therefore, it is required that signal transfer of the LD modulation signals is carried out stably at a high speed. In FIG. 2, each one of the LD driving parts 3a and 3b drives a respective one of the LDs 4a and 4b. However, another configuration may be provided instead in which a single LD driving part drives a plurality of LDs. Further, another configuration may be provided instead in which the LD driving parts 3a and 3b are configured in a single ASIC or on a single PCB. However, since the performance can be improved as a result of the LD driving parts 3a and 3b being disposed adjacent to the LDs 4a and 4b, respectively, the LD modulation data generating part 2 and the LD driving parts 3a and 3b are configured in separate PCBs, respectively, as shown in FIG. 3. Also, the LD modulation signals each of which is configured by a reduced amplitude differential signal (actually including two differential signals) are transmitted between the PCBs (described later with reference to FIGS. 4 through 6 and 15 through 24).

FIG. 3 shows a waveform when the LD modulation signal is transferred in a digital manner in the related art. When a full swinging signal is transmitted as shown in FIG. 3, an amplitude is large and thus, it is difficult to transfer pulse widths or such precisely. However, by applying a reduced amplitude differential signal (actually including two differential signals as shown in FIG. 4) as shown in FIG. 4, a level changing energy is reduced, and also, the signal is a differential signal. Thereby, the signal is robust against external disturbance, and therefore, it is possible to transfer pulse widths precisely. Thereby, it is possible to increase operation speed, improve EMI protection performance, improve noise protection performance and thus, to achieve a high definition in the LD modulation signal.

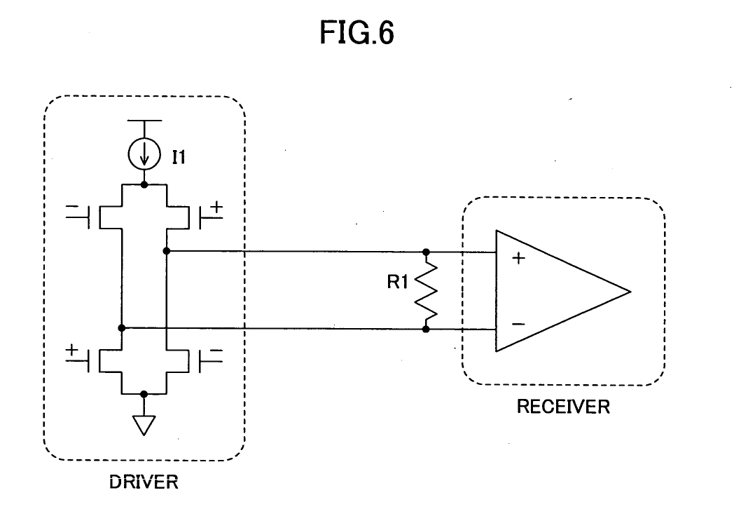

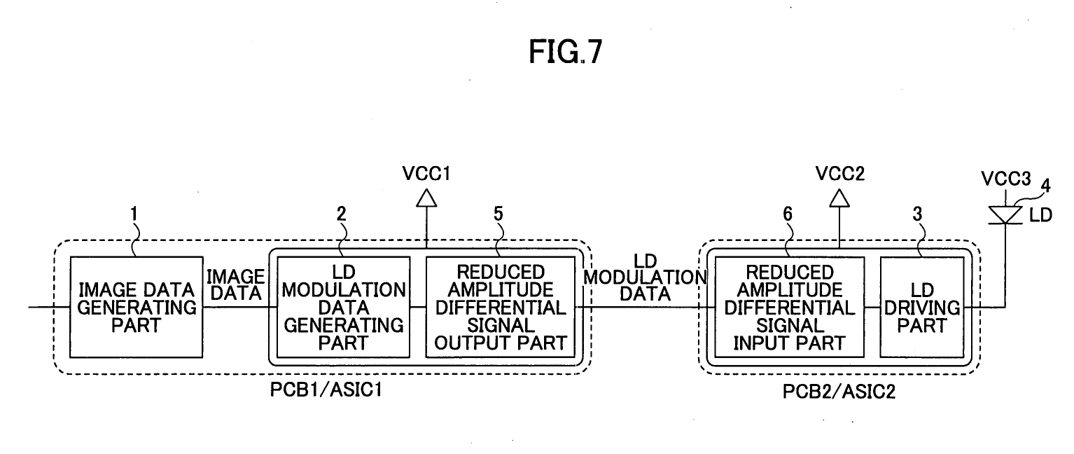

FIG. 5 shows one example thereof. As a result of a length of a transmission line being increased, time required for rising up and decaying down in a waveform increases, or, even in a case where the time required for rising up and decaying down in the waveform differ therebetween, a pulse width transferred by the differential signal is fixed, as shown in FIG. 5. Accordingly, it is possible to precisely transfer pulses. Therefore, this manner of applying a reduced amplitude differential signal is suitable for signal transmission in a pulse width modulation method. FIG. 6 shows a typical example of such a signal transfer method called LVDS (low voltage differential signaling). In this configuration, an electric current determined by a current source 11 on a driver side is injected to a transmission line, or, is drawn therefrom, and thereby, differential two signals are transferred with a voltage between terminal ends of a resistor R1. FIG. 7 shows one example applying such a configuration.

FIG. 7 shows a third configuration according to the first embodiment of the present invention. In the third configuration shown in FIG. 7, a transmission method with the use of a reduced amplitude differential signal described above is applied. In an output part of an LD modulation signal generating part 2, a reduced amplitude differential signal output part (driver part) 5 is provided. In an input part of an LD driving part 3, a reduced amplitude differential signal input part (receiver part) 6 is provided. Although FIG. 6 shows an example of LVDS, another method may be applied as long as a reduced amplitude differential signal transmission is carried out.

Further, in the configuration of FIG. 7, a power source voltage VCC1 is applied to an ASIC part mounting the LD modulation data generating part 2; a power source voltage VCC2 is applied to the LD driving part 3; and further, an LD power source voltage VCC3 is applied. Thus, the power source voltages different from each other are employed. Thereby, each block can be set to an optimum condition individually. For example, since VCC1 is applied to the LD modulation signal generating part 2 for which high speed operation is required, and also, which includes mainly a digital circuit generating the LD modulation signal, a fine process is selected for the device in this ASIC, and the power source voltage therefor should be a reduced one (for example, VCC: 1.2 V in a process of 0.13 μm, VCC: 1.8 V in a process of 0.18 μm).

As to VCC2, since this is the power source voltage for the LD driving part, a drop voltage of the LD plus a required electric potential for a transistor driving the LD is needed. Generally speaking, assuming that the drop voltage of the LD is 2.5 V, and the required electric potential for the transistor driving the LD is on the order of 1 V, a minimum 3.5 V is needed as VCC2. Although the power source voltage VCC3 for the LD is distinguished from the power source voltage VCC2 for the LD driving part, VCC3 may be common with VCC2, VCC3 and VCC2 may be provided from a same power source, or may have the same voltage value. However, when an ASIC is applied as mentioned above, a limitation exists in setting of a power source voltage in terms of the device itself, and thus, it is not possible to determine an arbitrary value therefor. Therefore, when it is required to reduce power consumption of the ASIC, setting may be made such that VCC2=5 V, and VCC3=3.5 V or such, for example. Thereby, it is possible to achieve effective reduction in the power consumption.

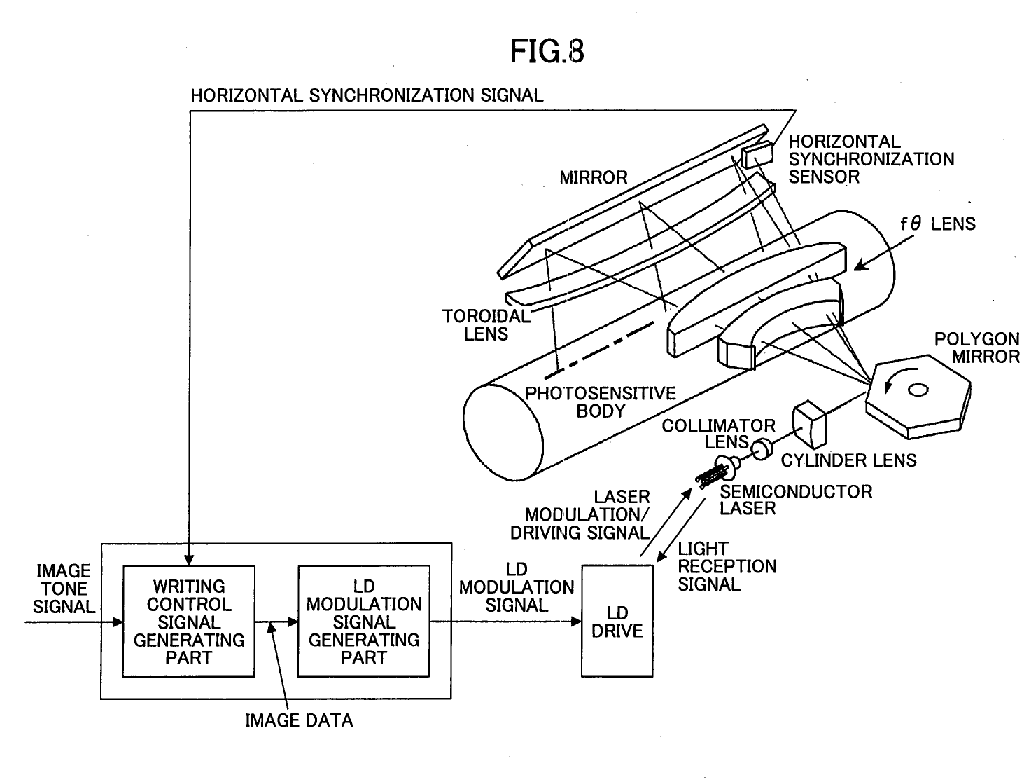

FIG. 8 shows an example of system configuration when the present invention is applied to a raster scanning image forming apparatus. An LD modulation signal generated by an LD modulation signal generating part is input to a semiconductor laser driving circuit, and modulates semiconductor laser light. The thus-modulated laser light is applied to a polygon mirror through a collimator lens and a cylinder lens. Then, the laser light is deflected by the polygon mirror, fθ lens. A writing start position is detected by a horizontal synchronization sensor, a detection signal thus obtained is input to a writing control signal generating part and an LD modulation signal generating part. Then, according to the horizontal synchronization signal and a given image signal, the writing control signal generating part and the LD modulation signal generating part output the LD modulation signal. The writing control signal generating part shown in FIG. 8 not only generates image data but also generates a writing control signal. Accordingly, the writing control signal generating part has a function of counters for a main scanning direction and a sub-scanning direction, or such. Therefore, in this configuration, the writing control signal generating part is provided instead of a simple image data generating part mentioned above.

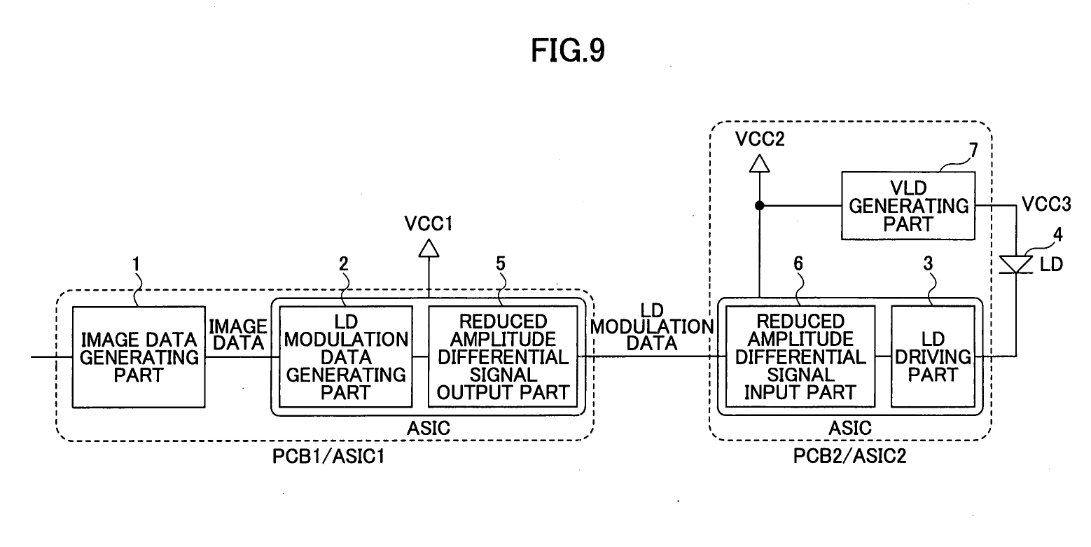

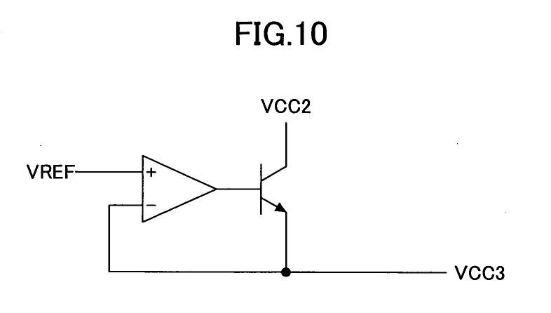

FIG. 9 shows a fourth configuration according to the first embodiment of the present invention. In this example shown in FIG. 9, VCC3 (<VCC2) is generated from VCC2 through a VLD generating part 7. Other than this part, the configuration of FIG. 9 is same as that of FIG. 7. FIG. 10 shows a specific example of a configuration of the VLD generating part. For example, when VCC3 is to be set as 3.5 V while VCC2 is to be set as 5 V, 3.5 V is input to a reference voltage input terminal VREF shown in FIG. 10. Thereby, a power source of 3.5 V is obtained as VCC3 shown. By providing a configuration to enable external input of VREF, it is possible to set an optimum value thereto such that, even when any type of the LD is connected, a power consumption in the LD driving part and operation in the LD driving part may become satisfactory in response to the particular type of LD actually applied. Thereby, it is possible to achieve both improvement in the LD driving performance and saving the power consumption. The VLD generating part 7 may be built in an ASIC of the LD driving part, or may be provided externally.

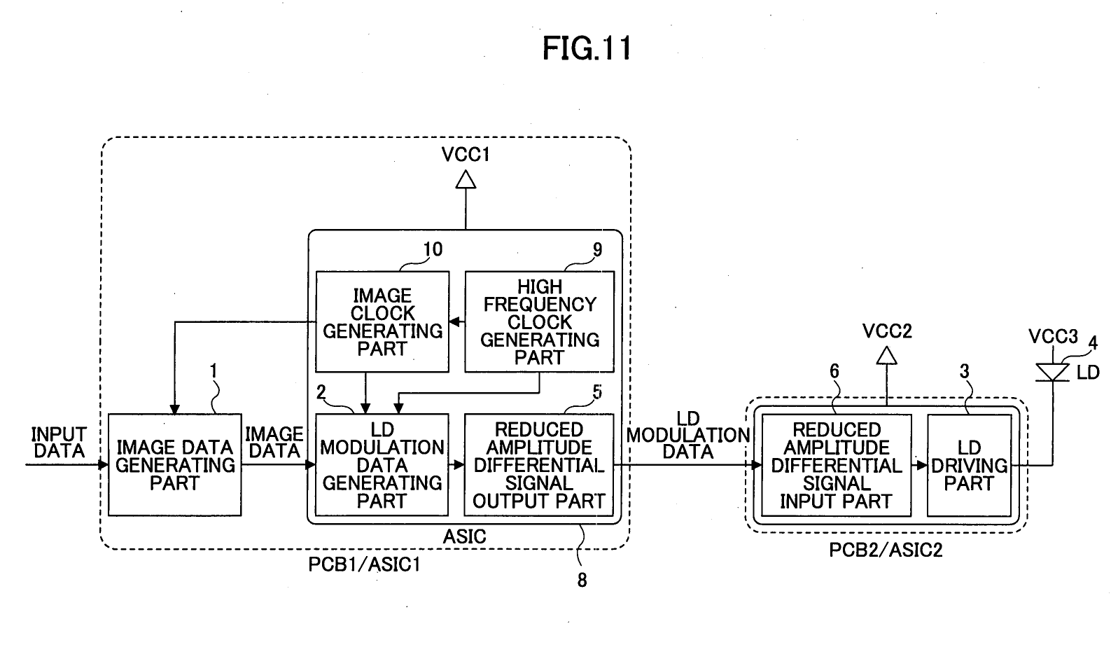

FIG. 11 shows a fifth configuration according to the first embodiment of the present invention. In this example, a block for which particularly high speed operation is required is configured in an ASIC 8. In the figure, an image data generating part is excluded from the ASIC. However, the image data generating part may also be included in the ASIC. A part for which high speed operation is especially required is described next. This part generally includes four blocks. A first block includes a high frequency clock generating part 9, which generates a clock signal with a frequency several times or tens of times of that or an image clock signal required.

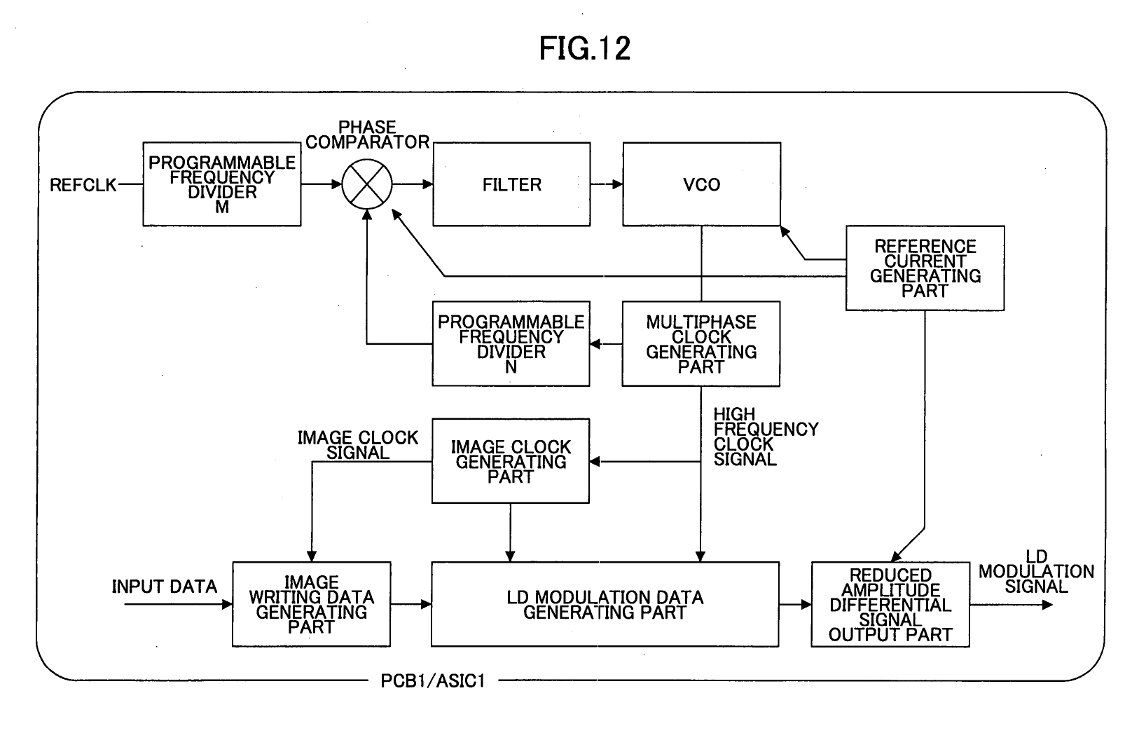

For this clock signal generation, as shown in FIG. 12, a frequency multiplication circuit may be employed with the use of a PLL circuit. By appropriately dividing in frequency of the thus-obtained high frequency clock signal, the image clock signal used as a reference signal when a copier or a printer forms an image may be obtained. Although not described in detail, in a case of a raster-type laser printer, an image clock generating part 10 should have a function of generating a synchronization clock signal for adjusting a writing position from a synchronization signal, a function of adjusting a scanning time interval with a clock signal for each color component in a case of a copier, a printer or a color machine.

Further, an LD modulation data generating part 2 is provided for generating an LD modulation signal data from a given image data based on the thus-generated image clock signal. Based on the LD modulation signal data thus generated, a reduced amplitude differential signal output part 5 transmits or transfers LD modulation data in a form of a reduced amplitude differential signal between ASICs or between PCBs. For the purpose of generating such a reduced amplitude differential signal, for example, the LVDS manner shown in FIG. 6, a CML (current mode logic) manner, an ECL (emitter coupled logic) manner or such may be utilized. In an LD driving part 3 which inputs the LD modulation signal in the form of reduced amplitude differential signal, there are many manners applicable to receive the reduced signal differential signal. However, generally speaking, the same manner as that in the output part 5 should be employed also in the input part 6. However, even the same manner is not employed, high speed signal transmission can also be carried out.

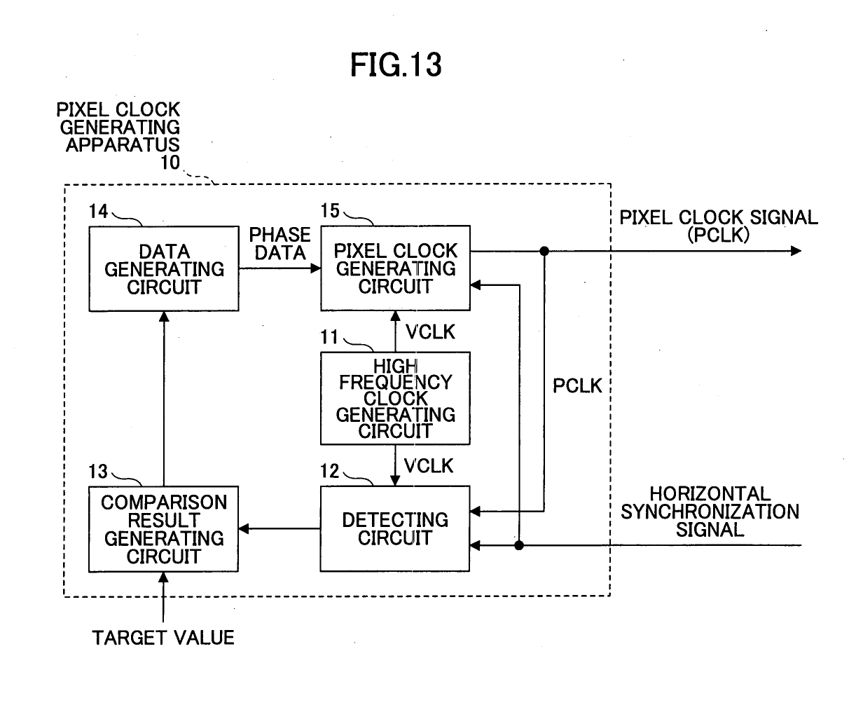

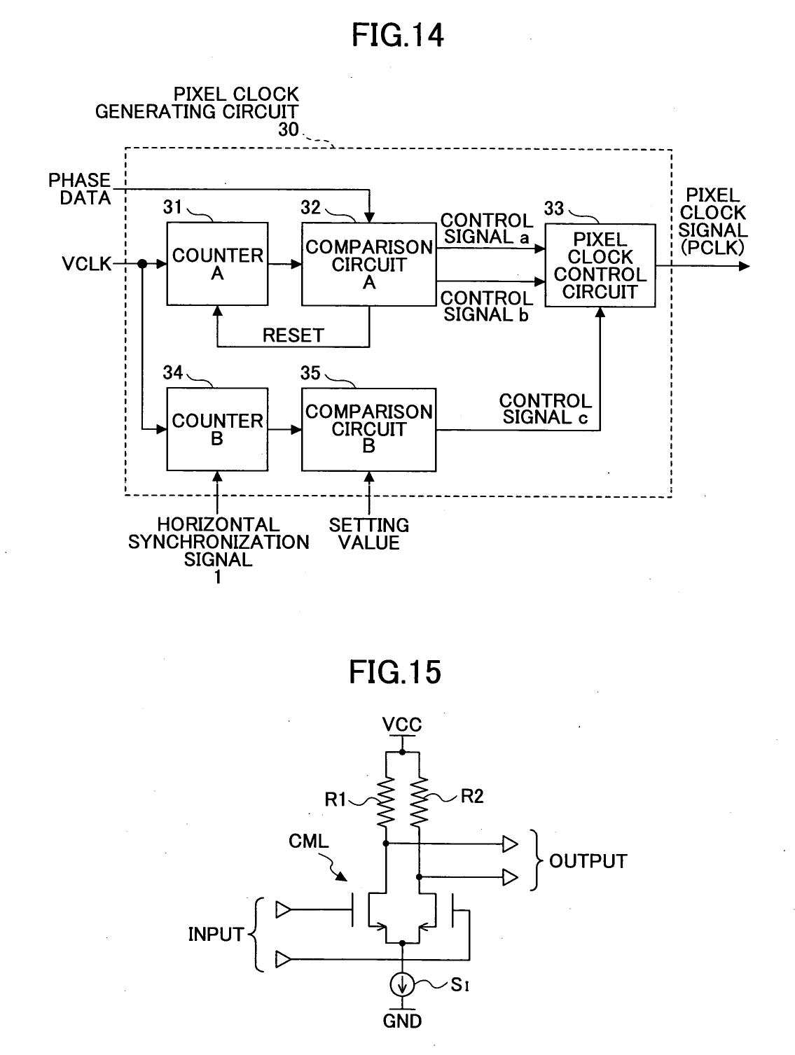

Next, a clock modulation part according to the present invention is described. Clock modulation described herein does not mean frequency modulation from a clock signal but it means shifting of a phase of a clock pulse in a digital manner individually. Such clock modulation is enabled from a configuration described now with reference to FIGS. 13 and 14. With the use of this clock modulation technology, it is possible to obtain a clock signal adapted to each color component from a common clock signal generated by a common clock generating part. Thereby, it is possible to provide a color image forming apparatus in which, from a single clock generating part, a clock signal generated therefrom can be modulated to obtain a particular clock signal (i.e., a pixel clock signal or such) adapted to each color component.

FIG. 13 shows a configuration of an image clock generating part (pixel clock generating apparatus) such as that shown in FIG. 12. In the figure, the pixel clock generating apparatus 10 includes a high frequency clock generating circuit 11, a detecting circuit 12, a comparison result generating circuit 13, a data generating circuit 14 and a pixel clock generating circuit 15. The high frequency clock generating circuit 11 generates a high frequency clock signal VCLK which is used as a reference signal for generating a pixel clock signal PCLK. The detecting circuit 12 includes a counter detecting a time interval from a time at which a first horizontal synchronization signal is input until a time at which a second horizontal synchronization signal is input. The comparison result generating circuit 13 obtains a difference between a count value output from the detecting circuit 12 and a target value which is previously set. The data generating circuit 14 generates phase data based on the comparison result output from the comparison result generating circuit 13. The pixel clock generating circuit 15 generates the pixel clock signal PCLK based on the phase data and the high frequency clock signal VCLK.

FIG. 14 shows a configuration of a pixel clock generating circuit 30 applicable as the above-mentioned pixel clock generating circuit 15. As shown, the pixel clock generating circuit 30 includes counters 31, 34, comparison circuits 32, 35, and a pixel clock control circuit 33. The counters 31, 34 operate in response to a rising edge of the high frequency clock signal VCLK, and thus count clock pulses of the high frequency clock signal VCLK. The comparison circuits 32, 35 compare the count value with a previously set value and the phase data which indicates a phase shift amount as pixel clock transmission timing given externally, and output control signals ‘a’ and a control signal ‘b’ as comparison results, respectively. The pixel clock control circuit 33 controls transition timing in the pixel clock signal PCLK to be output based on the control signals ‘a’ and ‘b’. In this configuration, it is possible to provide a phase shift for each image clock pulse in a digital manner (see Japanese Laid-open Patent Application No. 2002-36626 filed by the same applicant as mentioned above).

A method for generating the above-mentioned reduced amplitude differential signal according to a second embodiment of the present invention is described next. Although a part outputting the reduced amplitude differential signal described now is configured in a single stage of an inverter, the present invention may also be applied to a configuration in which the part outputting the reduced amplitude differential signal is configured by a plurality of stages of inverters or buffers, instead.

FIG. 15 shows a first configuration according to the second embodiment of the present invention. In this configuration, a differential signal is input to a CML circuit CML, and resistors (or resistances) R1 and R2 are applied as loads of the CML circuit CML. In this configuration, it is possible to reduce output amplitude of the CML circuit CML to be smaller than VCC. Further, by adjusting values of the resistors (or resistances) R1 and R2, the output amplitude can be controlled.

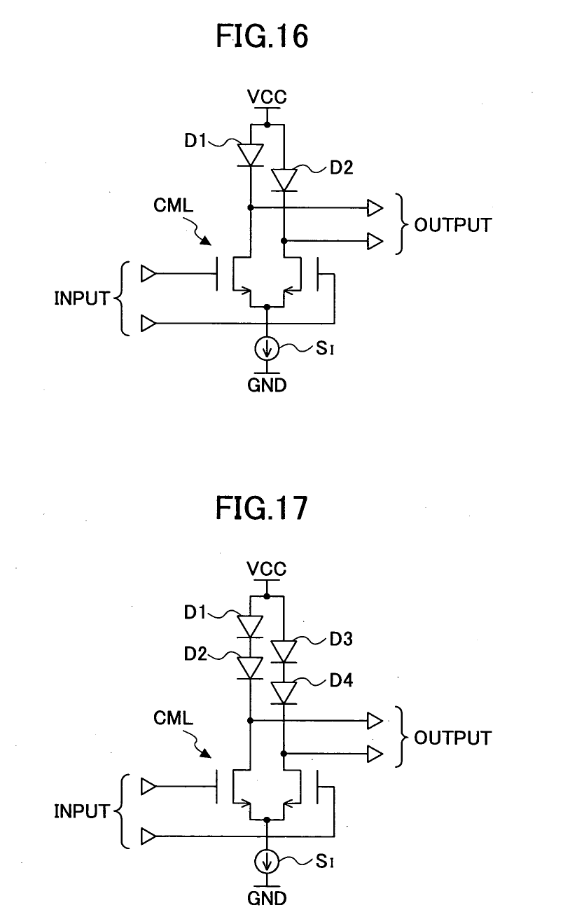

FIG. 16 shows a second configuration according to the second embodiment of the present invention. In this configuration, a differential signal is input to a CML circuit CML, and diodes D1 and D2 are applied as loads of the CML circuit CML. In this configuration, it is possible to reduce output amplitude of the CML circuit CML to be smaller than VCC by a drop voltage of the diodes D1 and D2. Further, by adjusting sizes of the diodes D1 and D2, the output amplitude can be controlled.

FIG. 17 shows a third configuration according to the second embodiment of the present invention. In this configuration, two stages of diodes D1, D2 and D3, D4 are provided instead of the diodes D1 and D2 in the configuration shown in FIG. 16. In this configuration, it is possible to reduce output amplitude of the CML circuit CML to be smaller than VCC by a drop voltage of the two stages of the diodes D1, D2 and D3, D4. Further, by adjusting sizes of the diodes D1, D2, D3 and D4, the output amplitude can be controlled.

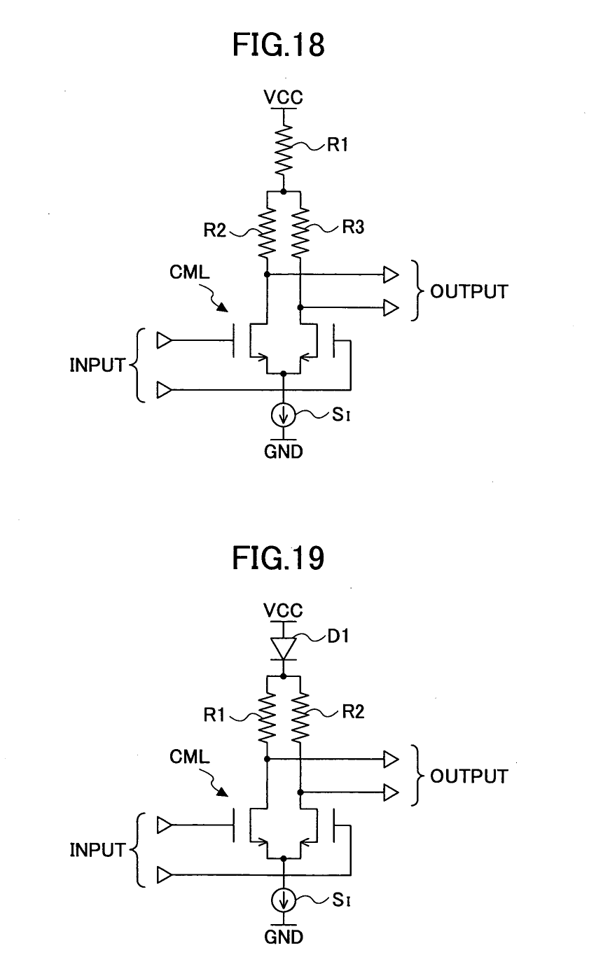

FIG. 18 shows a fourth configuration according to the second embodiment of the present invention. In this configuration, in addition to two resistors R2 and R3 as those R1 and R2 in the configuration of FIG. 15, a further resistor (or a resistance) R1 is inserted between VCC and the resistors (or resistances) R2 and R3. Thereby, it is possible to lower a reference electric potential from VCC. As a result, it is possible to reduce the output amplitude of the CML circuit CML. Furthermore, it is possible to control the output amplitude by adjusting the value of the resistor (or resistance) R1.

FIG. 19 shows a fifth configuration according to the second embodiment of the present invention. In this configuration, in addition to two resistors R1 and R2 as those in the configuration of FIG. 15, a further diode D1 is inserted between VCC and the resistors R1 and R2. Thereby, it is possible to lower a reference electric potential from VCC by a drop voltage of the diode D1. As a result, it is possible to reduce the output amplitude of the CML circuit CML. Furthermore, it is possible to control the output amplitude by adjusting the size of the diode D1.

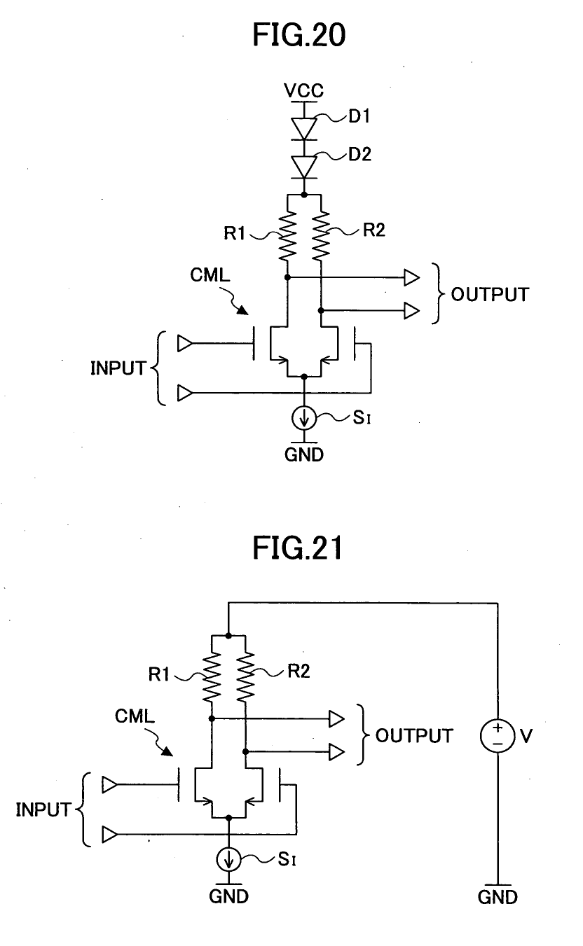

FIG. 20 shows a sixth configuration according to the second embodiment of the present invention. In this configuration, two stages of diodes D1 and D2 are provided instead of the single diode D1 in the configuration of FIG. 19. Thereby, it is possible to lower a reference electric potential from VCC by a drop voltage of the two stages of diodes D1 and D2. As a result, it is possible to reduce the output amplitude of the CML circuit CML. Furthermore, it is possible to control the output amplitude by adjusting the sizes of the diodes D1 and D2.

FIG. 21 shows a seventh configuration according to the second embodiment of the present invention. In this configuration, VCC in the configuration of FIG. 15 is replaced by a voltage source V. In this configuration, it is possible to obtain a desired reference voltage, and thus, it is possible to set the output amplitude of the CML circuit CML to a desired value.

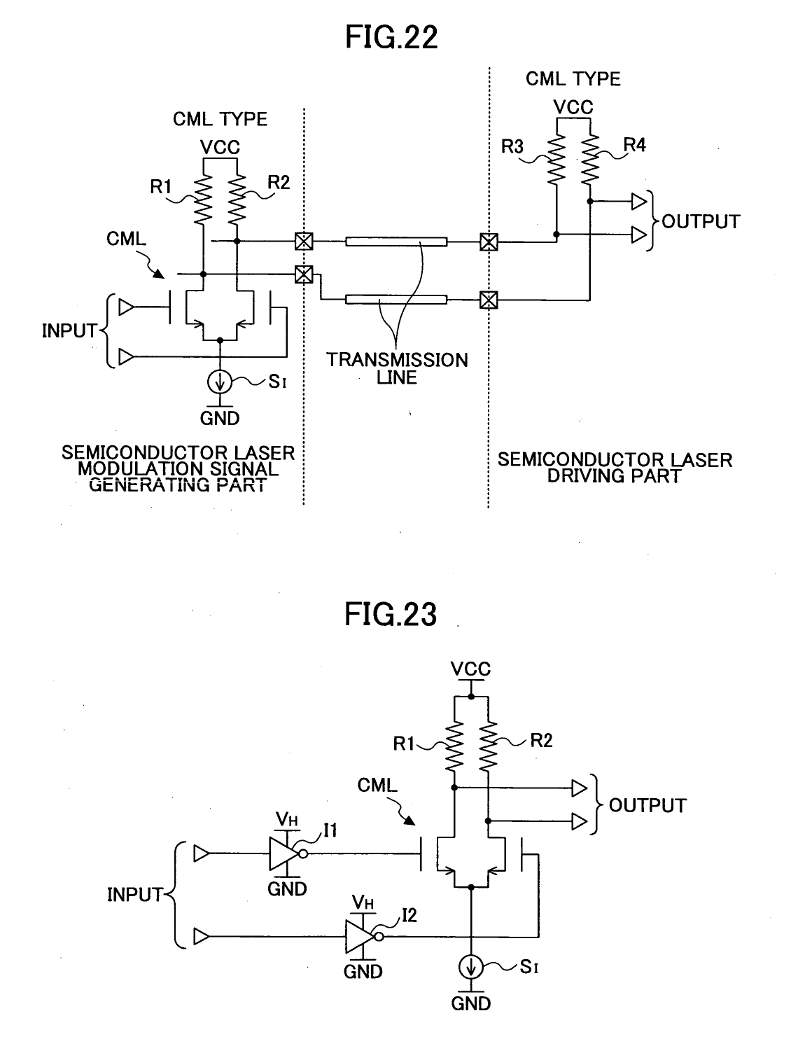

FIG. 22 shows an eighth configuration according to the second embodiment of the present invention. In this configuration, both the output part in the semiconductor laser modulation signal generating part and the input part in the semiconductor laser driving part are configured by CML circuits CML, respectively. Thereby, it is possible to achieve the high speed signal transmission between the semiconductor laser driving part and the semiconductor laser modulation signal generating part.

FIG. 23 shows a ninth configuration according to the second embodiment of the present invention. In this configuration, an amplitude of an input signal to a CML circuit CML is previously reduced. In this configuration, inverters I1 and I2 are inserted before the CMP circuit CML, and a power source voltage V_{H} Of the inverters I1 and I2 is set lower than a power source voltage VCC of the CML circuit CML. Thereby, it is possible to set the amplitude of the input signal of the CML circuit CML to V_{H} smaller than VCC. As a result, it is possible to reduce fluctuation in a current source connected to the CML circuit possibly occurring due to switching operation and to improve the switching speed.

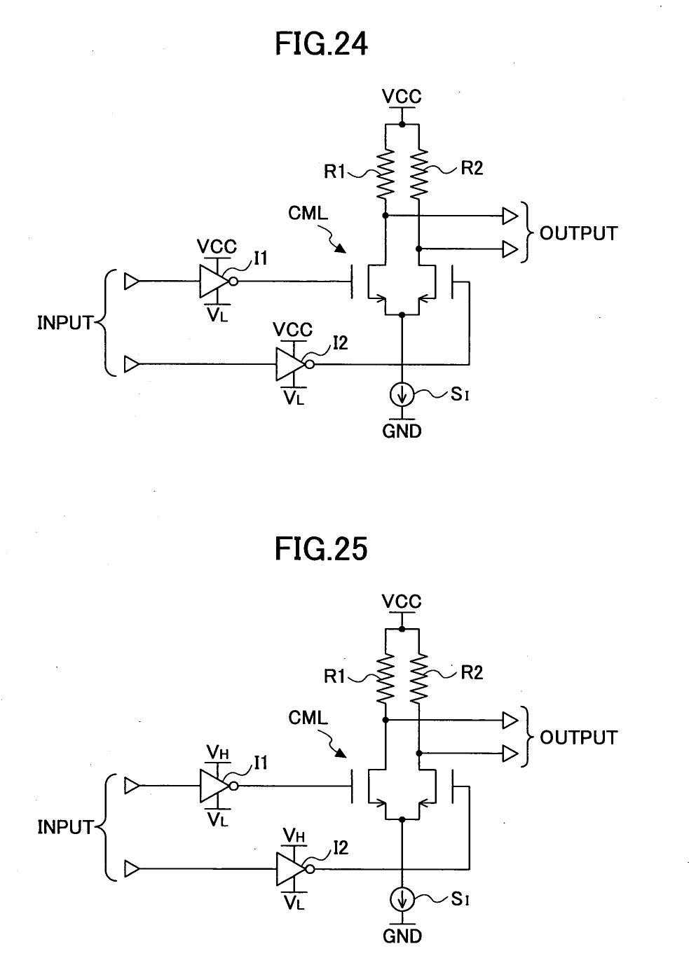

FIG. 24 shows a tenth configuration according to the second embodiment of the present invention. In this configuration, an amplitude of an input signal to a CML circuit CML is previously reduced. In this configuration, inverters I1 and I2 are inserted before the CMP circuit CML, and a ground voltage V_{L} of the inverters I1 and I2 is set higher than a ground voltage GND of the CML circuit CML. Thereby, it is possible to set amplitude of the input signal of the CML circuit CML to VCC-V_{L} smaller than VCC. As a result, it is possible to reduce fluctuation of a current source connected to the CML circuit possibly occurring due to switching operation and to improve the switching speed.

FIG. 25 shows an eleventh configuration according to the second embodiment of the present invention. In this configuration, an amplitude of an input signal of a CML circuit CML is previously reduced. In this configuration, inverters I1 and I2 are inserted before the CMP circuit CML, a power source voltage VH Of the inverters I1 and I2 is set lower than a power source voltage VCC of the CML circuit CML and also, a ground voltage V_{L} of the inverters I1 and I2 is set higher than a ground voltage GND of the CML circuit CML. Thereby, it is possible to set amplitude of the input signal of the CML circuit CML to V_{H}-V_{L} smaller than VCC. As a result, it is possible to reduce fluctuation of a current source connected to the CML circuit possibly occurring due to switching operation and to improve the switching speed.

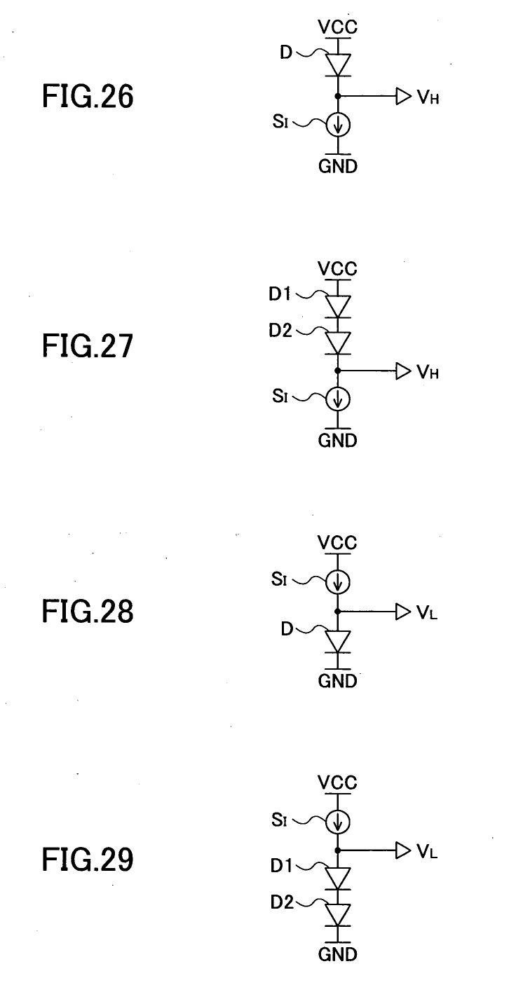

FIG. 26 shows a twelfth configuration according to the second embodiment of the present invention. This configuration provides a high electric potential V_{H} to be applied as the power source voltage V_{H} of the inverters I1 and I2 shown in FIG. 23 or 25. In this configuration, a cathode of a diode D is connected to a power source voltage VCC, and an anode of the diode D is connected to a current source S_{I}. In this configuration, it is possible to stably take the high electric potential V_{H} which is lower than VCC by a drop voltage of the diode D. Further, it is possible to obtain a desired value of V_{H} by adjusting a size of the diode D and a current value of the current source S_{I}.

FIG. 27 shows a thirteenth configuration according to the second embodiment of the present invention. This configuration provides in another manner the high electric potential V_{H} to be applied as the power source voltage V_{H} of the inverters I1 and I2 shown in FIG. 23 or 25. In this configuration, instead of the diode D in the configuration of FIG. 26, two stages of diodes D1 and D2 are used. In this configuration, it is possible to stably take the high electric potential V_{H} which is lower than VCC by a drop voltage of the two stages of diodes D1 and D2. As a result, it is possible to obtain a value of V_{H} smaller than that in the configuration with the single diode D of FIG. 26. Further, it is possible to obtain a desired value of V_{H} by adjusting sizes of the diodes D1 and D2 and a current value of the current source S_{I}.

FIG. 28 shows a fourteenth configuration according to the second embodiment of the present invention. This configuration provides a low electric potential V_{L} to be applied as the ground voltage V_{L} Of the inverters I1 and I2 shown in FIG. 24 or 25. In this configuration, an anode of a diode D is connected to a ground voltage GND, and a cathode of the diode D is connected to a current source S_{I}. In this configuration, it is possible to stably take the low electric potential V_{L} which is higher than GND by a drop voltage of the diode D. Further, it is possible to obtain a desired value of V_{L} by adjusting a size of the diode D and a current value of the current source S_{I}.

FIG. 29 shows a fifteenth configuration according to the second embodiment of the present invention. This configuration provides in another manner the low electric potential V_{H} to be applied as the ground voltage V_{L} of the inverters I1 and I2 shown in FIG. 24 or 25. In this configuration, instead of the diode D in the configuration of FIG. 28, two stages of diodes D1 and D2 are used. In this configuration, it is possible to stably take the low electric potential V_{L} which is higher than GND by a drop voltage of the two stages of diodes D1 and D2. As a result, it is possible to obtain a value of V_{L} higher than that in the configuration with the single diode D of FIG. 28. Further, it is possible to obtain a desired value of V_{L} by adjusting sizes of the diodes D1 and D2 and a current value of the current source S_{I}.

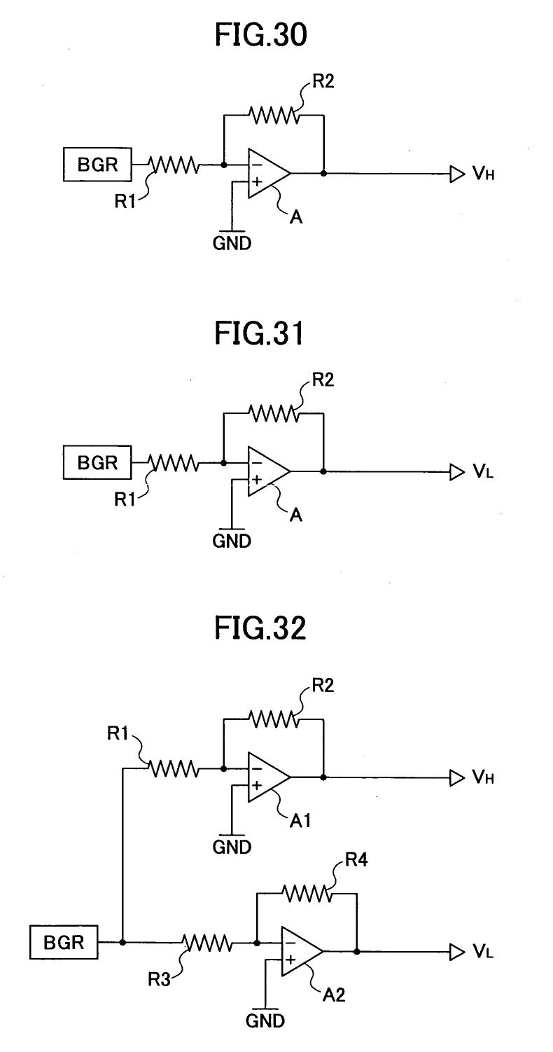

FIG. 30 shows a sixteenth configuration according to the second embodiment of the present invention. This configuration provides in another manner the high electric potential V_{H} to be applied as the power source voltage V_{H} of the inverters I1 and I2 shown in FIG. 23 or 25. In this configuration, output of a BGR (band gap reference) circuit BGR is input to an operational amplifier A. In this configuration, it is possible to stably obtain a desired value of V_{H}.

FIG. 31 shows a seventeenth configuration according to the second embodiment of the present invention. This configuration provides in another manner the low electric potential V_{L} to be applied as the ground voltage V_{L} of the inverters I1 and I2 shown in FIG. 24 or 25. In this configuration, output of a BGR (band gap reference) circuit BGR is input to an operational amplifier A. In this configuration, it is possible to stably obtain a desired value of V_{L}.

FIG. 32 shows an eighteenth configuration according to the second embodiment of the present invention. This configuration provides in another manner the high electric potential V_{H} to be applied as the power source voltage V_{H} of the inverters I1 and I2 and also the low electric potential V_{L} to be applied as the ground voltage V_{L} of these inverters I1 and I2 shown in FIG. 25. In this configuration, output of a BGR (band gap reference) circuit BGR is input to respective operational amplifiers A1 and A2. In this configuration, it is possible to stably obtain a desired value of V_{H} and a desired value of V_{L} simultaneously.

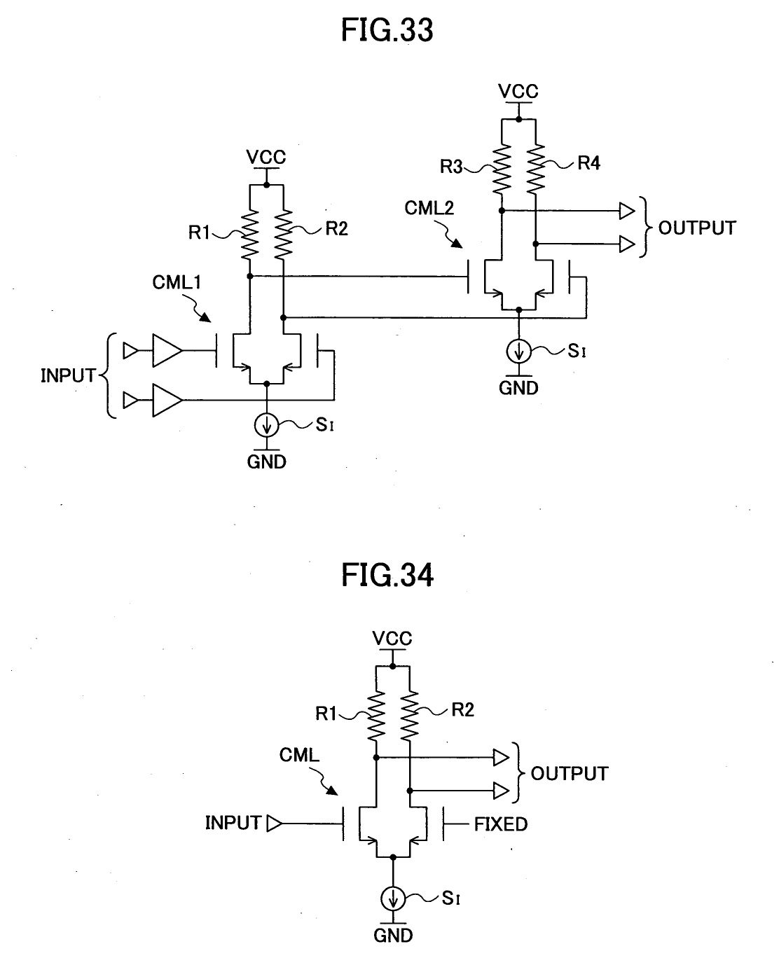

FIG. 33 shows a nineteenth configuration according to the second embodiment of the present invention. In this configuration, two stages of CML circuits are applied. In this configuration, a differential signal is input to the first stage of the CML circuit CML1, and output of the CML circuit CML1 is provided to the second stage of the CML circuit CML2. In this configuration, it is possible to reduce an amplitude of the input signal of the second stage of the CML circuit CML2. Thereby, it is possible to reduce fluctuation in a current source Sᵢ possibly occurring due to switching operation in the input of the second stage of the CML circuit CML2. It is also possible to apply more than two stages of CML circuits instead of the two stages of the CML circuits.

FIG. 34 shows a twentieth configuration according to the second embodiment of the present invention. In this configuration, to one input of a CML circuit CML, a fixed voltage is applied, while, a switching signal is applied to the other input. In this configuration, it is possible to output a differential signal having a reduced amplitude. Further, by controlling values of resistances of load resistors (or resistances) R1 and R2, it is possible to adjust the amplitude of an output voltage.

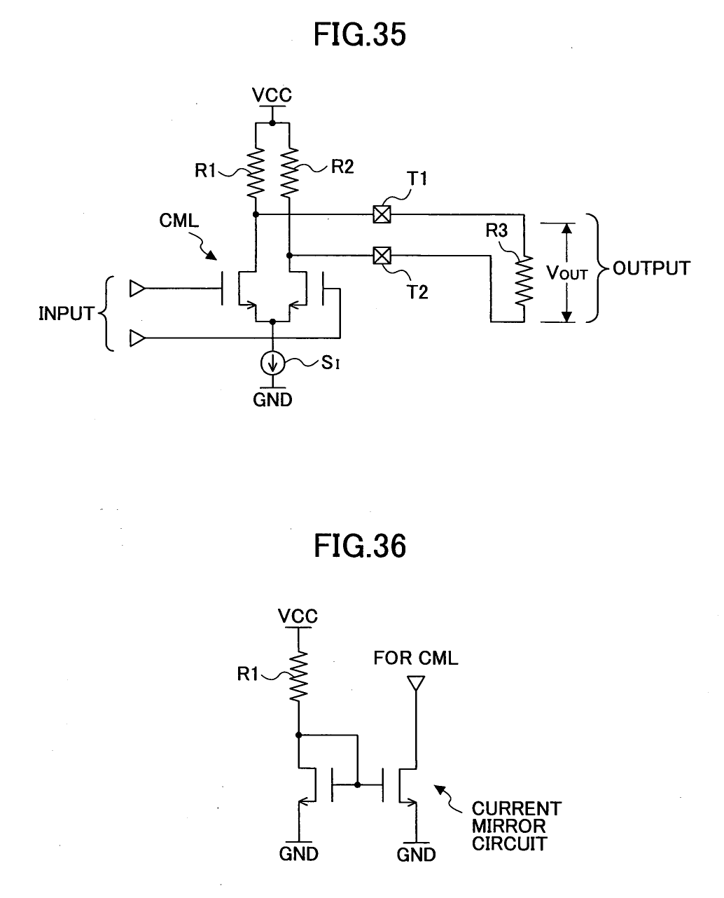

FIG. 35 shows a twenty-first configuration according to the second embodiment of the present invention. In this configuration, a differential output signal of a CML circuit CML is terminated with a resistor (or a resistance) R3. In this configuration, a differential signal can be taken at a receiving end of the signal transmission.

FIG. 36 shows a twenty-second configuration according to the second embodiment of the present invention. This configuration provides a current source applicable as that S_{I} in the configuration shown in FIG. 15-25 and 33-35. In this configuration, a current value of the current source is set with a power source voltage VCC and a value of a resistance of a resistor (or a resistance) R1, and the current value is then reflected by means of a current mirror circuit shown. In this configuration, in a case where loads of a CML circuit is configured by resistance elements in an integrated circuit, it is possible to reduce a variation in an output amplitude possibly occurring due to a variation in the resistance values.

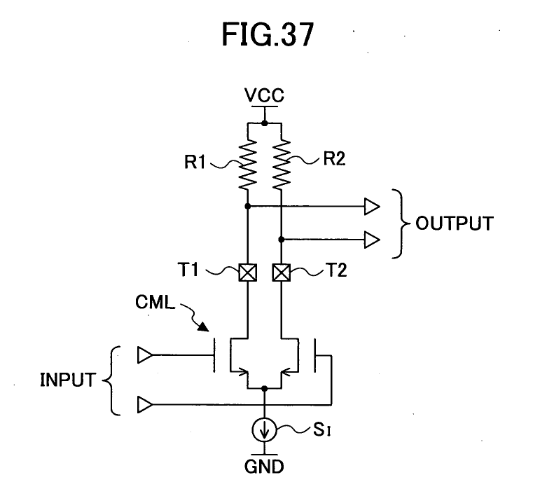

FIG. 37 shows a twenty-third configuration according to the second embodiment of the present invention. In this configuration, loads of a CML circuit CML are provided as external components. By employing such external components which have well controlled variation, it is possible to obtain output amplitude having a precise value.

In each of the configuration shown in FIGS. 15-37 or such, resistors R1, R2, R3, R4 and so forth should not necessarily be actual resistor devices, and may be configured by other devices such as transistors or such in a well-known manner.

A third embodiment of the present invention is described next.

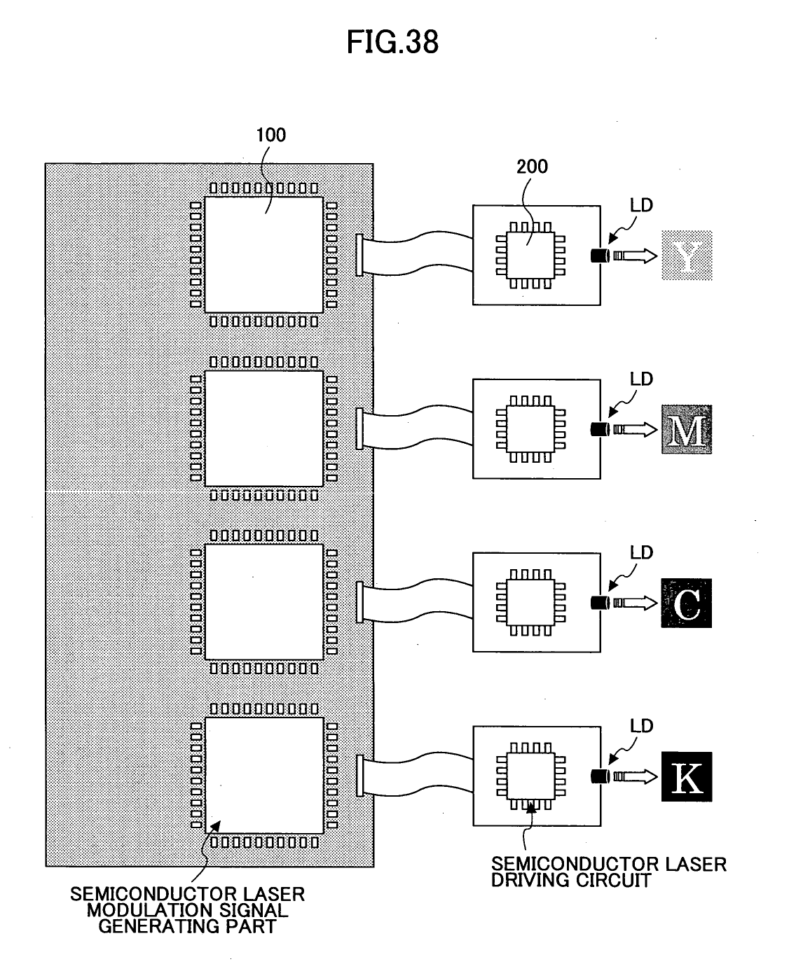

FIG. 38 shows a configuration of semiconductor laser modulation signal generating parts and semiconductor laser driving parts in a tandem-type color machine in the related art. In this configuration, a semiconductor laser modulation signal generating part 100 and a semiconductor laser driving part 200 are provided for each of the respective color components, i.e., yellow (Y), magenta (M), cyan (C) and black (K). In this configuration, a reference clock signal is adjustable for each color component, and thus, the configuration is superior in terms of versatility. In the configuration of FIG. 38, the semiconductor laser modulation signal generating part 100 may have a configuration which includes the LD modulation data generating part 2 shown in FIG. 1 or such; includes both the image data generating part 1 and the LD modulation data generating part 2 as shown in FIG. 1 or such; or includes both the image data generating part 1 and the LD modulation data generating part 2 as well as the reduced amplitude differential signal output part 5 (in this case, the reduced amplitude differential signal input part is included in the semiconductor laser driving part 200) as shown in FIG. 7 or such.

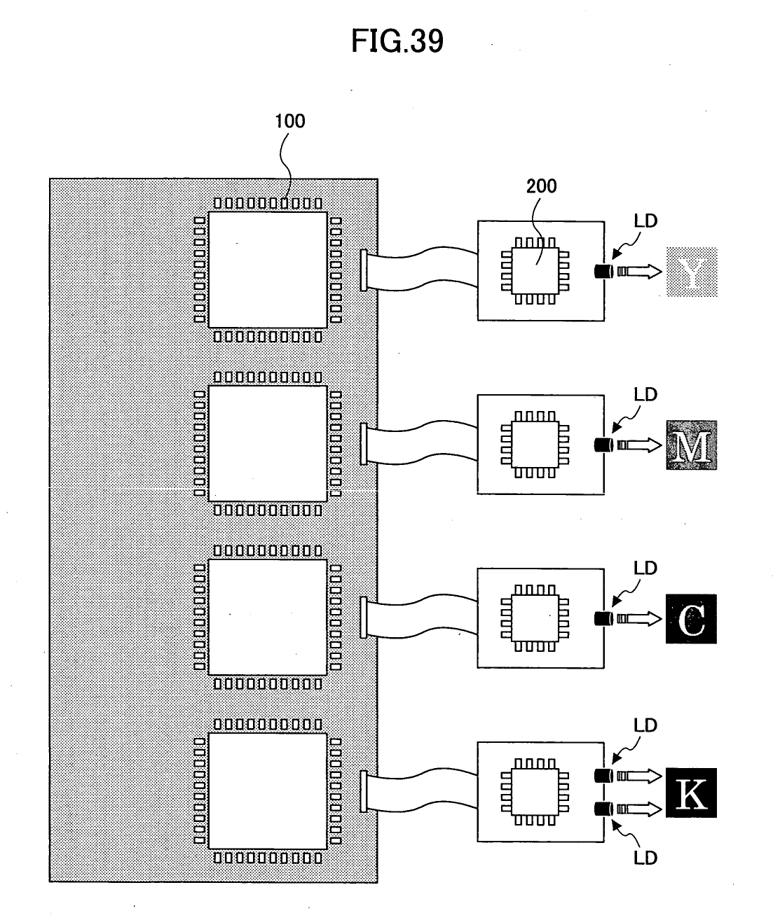

FIG. 39 shows a first configuration according to the third embodiment of the present invention. This configuration is different from that of FIG. 38 in that two semiconductor lasers LDs are provided for the color component of black (K) as shown. In this configuration, since the two lasers (LDs) are used for the color component K which has a high usage frequency, it is possible to increase a writing speed therefor.

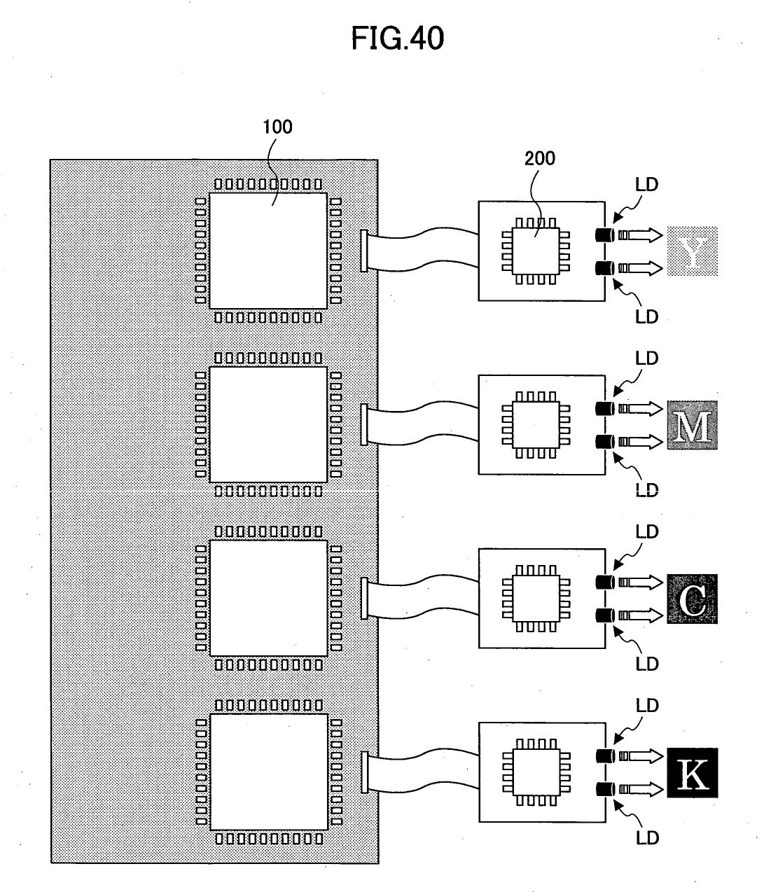

FIG. 40 shows a second configuration according to the third embodiment of the present invention. This configuration is different from that of FIG. 38 in that two semiconductor lasers LDs are provided for each of the respective color components Y, M, C and K. In this configuration, since the two lasers (LDs) are used for each of all the color components, it is possible to increase a writing speed for each of the color components.

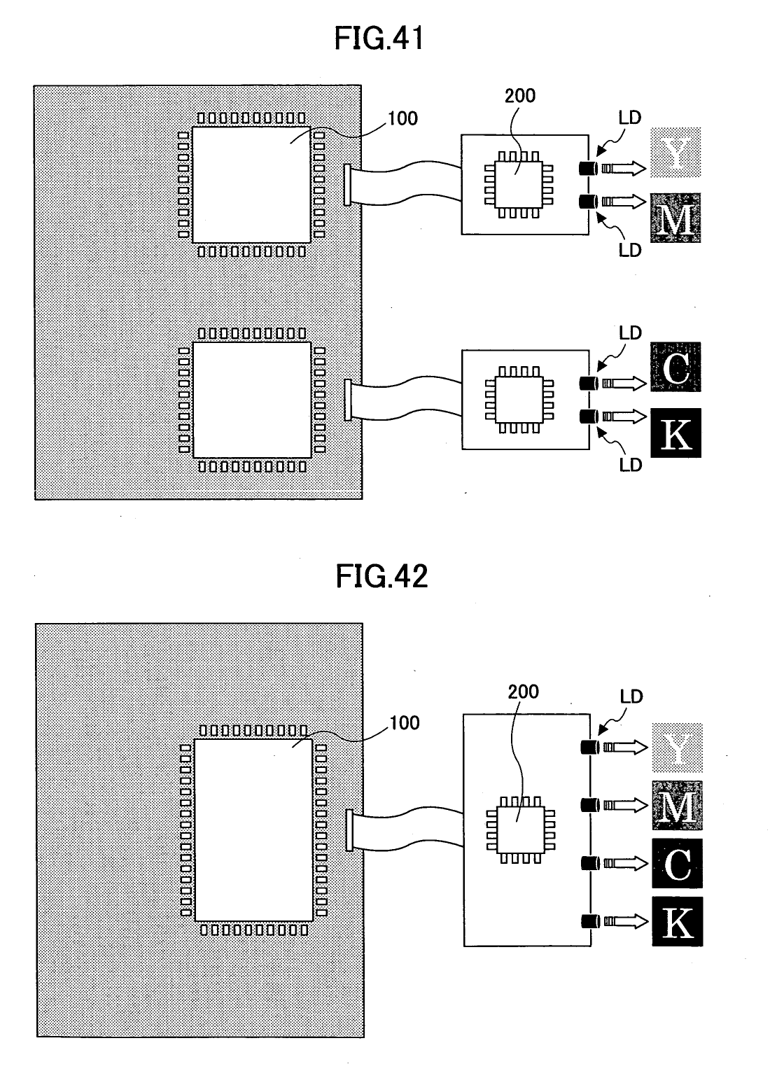

FIG. 41 shows a third configuration according to the third embodiment of the present invention. This configuration is different from that of FIG. 38 in that the semiconductor laser modulation signal generating part(s) 100 and the semiconductor laser driving part(s) 200 are configured in single semiconductor chips, respectively, for each two color components Y and M or C and K, as shown. In this configuration, a common reference clock should be applied to the two color components configured in the common semiconductor chip. However, by means of clock modulation technology described above with reference to FIGS. 13 and 14, it is possible to apply different pixel clock signals for the respective two color components generated from the common reference clock signal. Also, the overall configuration can be miniaturized and simplified.

FIG. 42 shows a fourth configuration according to the third embodiment of the present invention. This configuration is different from that of FIG. 38 in that the semiconductor laser modulation signal generating part(s) 100 and the semiconductor laser driving part(s) 200 are configured in single semiconductor chips, respectively, for all the four color components Y, M, C and K, as shown. In this configuration, a common reference clock should be applied to all the four color components configured in the common semiconductor chip. However, by means of clock modulation technology described above with reference to FIGS. 13 and 14, it is possible to apply different pixel clock signals for the respective four color components generated from the common reference clock signal. Also, the overall configuration can be miniaturized and simplified.

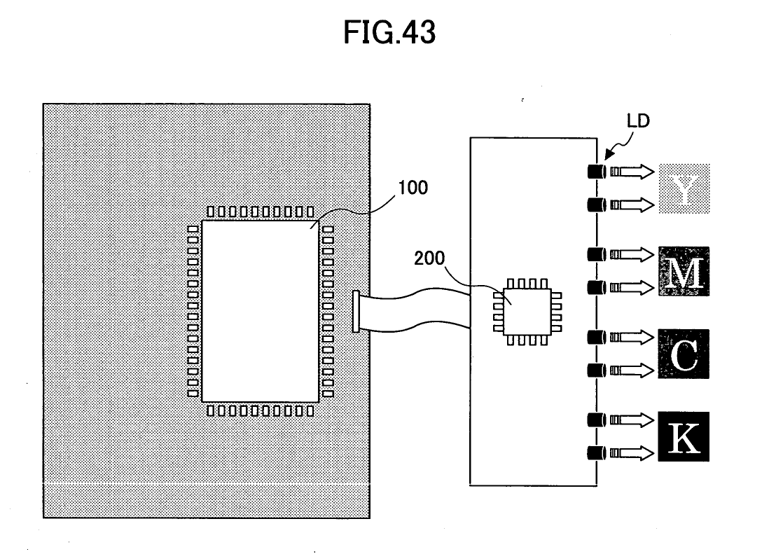

FIG. 43 shows a fifth configuration according to the third embodiment of the present invention. This configuration is different from that of FIG. 42 in that two semiconductor lasers LDs are provided for each of the four color components Y, M, C and K. In this configuration, since the two lasers (LDs) are used for the color component K which has a high usage frequency, it is possible to increase a writing speed for each of the color components.

A fourth embodiment of the present invention is described next.

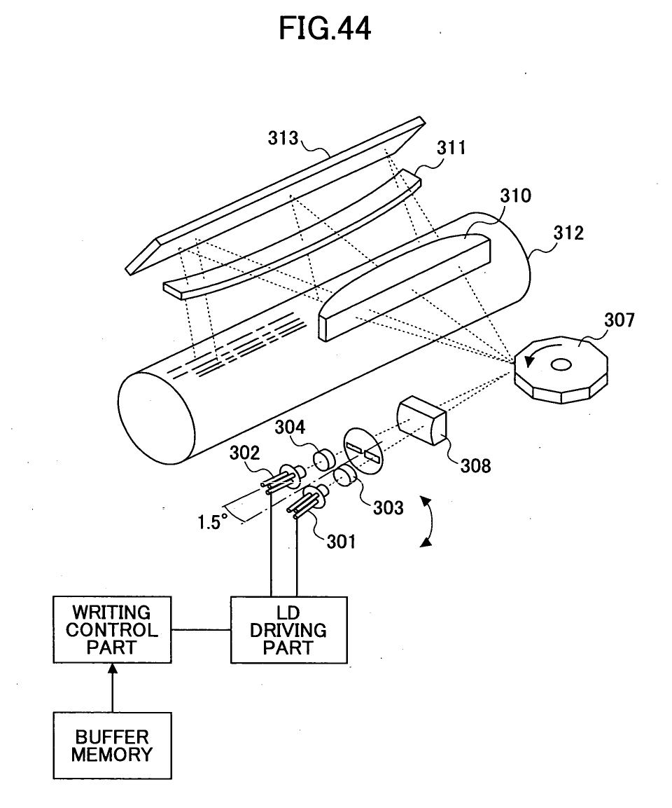

In an image forming apparatus according to the fourth embodiment of the present invention, as a light source, a multi-beam light source configured by a semiconductor laser array in which a plurality of semiconductor lasers are optically combined, or a monolithic semiconductor laser array is applied. FIG. 44 shows a configuration of a multi-beam scanning apparatus according to the fourth embodiment of the present invention. In the fourth embodiment, two semiconductor lasers are used, and are disposed along a sub-scanning direction symmetrical about optical axes of collimator lenses.

In this configuration, the semiconductor lasers 301, 302 are disposed to have optical axes coincide with those of the collimator lenses 303, 304, are made to have symmetrical light emitting angles in the sub-scanning direction, and are disposed so that the light emitting axes may intersect at a point at which they are reflected by a polygon mirror 307. A plurality of beams emitted by the respective semiconductor lasers are deflected by the polygon mirror 307 collectively after passing through a cylindrical lens 308, and form images on a photosensitive body 312 through an fθ lens 310 and a toroidal lens 311.

Printing data is stored in a buffer memory for each light source for one line, the printing data is read out therefrom for each reflective surface of the polygon mirror 307, and is recorded for each two lines simultaneously.

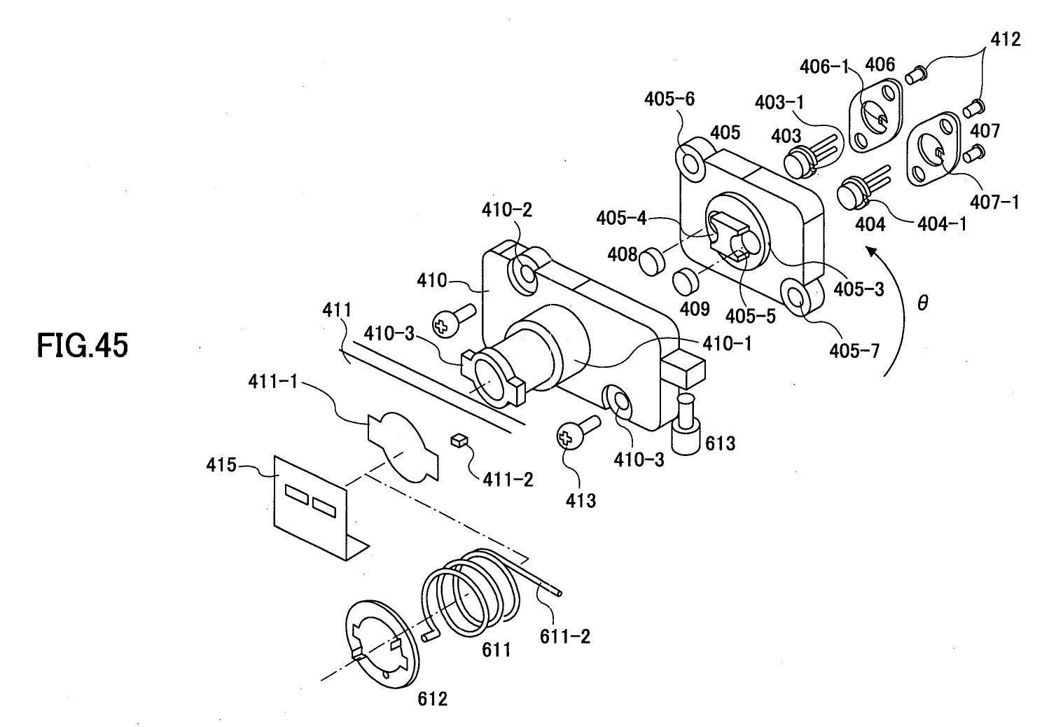

FIG. 45 shows details of the light source unit of the scanning apparatus shown in FIG. 44. As shown, the semiconductor lasers 403, 404 (corresponding to those 301, 302 mentioned above) are fixed to a back side of a base member 405 with screws 412 while cylindrical heat sink parts 403-1, 403-2 thereof are individually fitted into fitting holes 405-1, 405-2 not shown formed on the back side of the base member 405 each of which is inclined slightly by a predetermined angle in the sub-scanning direction, approximately 1.5° in the embodiment, and projections in pressing members 406, 407 are aligned with cut-out parts of the heat sink parts so that a mounting direction of each of the light sources may be adjusted.

Further, the collimator lenses 408, 409 (corresponding to those 303, 304 mentioned above) are made to undergo adjustment of their optical axes with peripheries thereof fitted with hemisphere mounting guide surfaces 405-4, 405-5 of the base member 405, respectively, and are caused to adhere thereto while positioning is made in such a manner that divergent beams emitted from light emitting points may become parallel beams. According to the fourth embodiment, since setting is made such that light beams emitted from the respective semiconductor lasers may intersect in a main scanning plane as mentioned above, the fitting holes 405-1, 405-2, and the hemisphere mounting guide surfaces 405-4, 405-5 are made to incline along the light beams. The base member 405 is fixed to a holder member 410 as a result of a cylindrical engagement part 405-3 thereof being engaged to the holder member 410, and screws 405 being inserted into screw holes 405-6, 405-7, and thus, the light source unit is produced.

The holder member 410 of the above-mentioned light source unit is mounted closely to a back side of a mounting wall 411 of an optical housing as a result of a cylindrical part 410-1 thereof being fitted into a reference hole 411-1 provided in the mounting wall 411, a spring 611 being inserted from a front side and a stopper member 612 being engaged with a cylindrical projection 410-3. At this time, one end of the spring 611 is engaged with a projection 411-2 on the mounting wall 411, thereby, rotation force occurs about a cylindrical part, and, then, an adjustment screw 613 provided to receive the rotation force is used to rotate the entirety of the light source unit in a direction 0, and to adjust a pitch. In an aperture 415, slits are formed for the respective ones of the semiconductor lasers, and the aperture 415 is mounted to the optical housing for defining the respective light beam diameters.

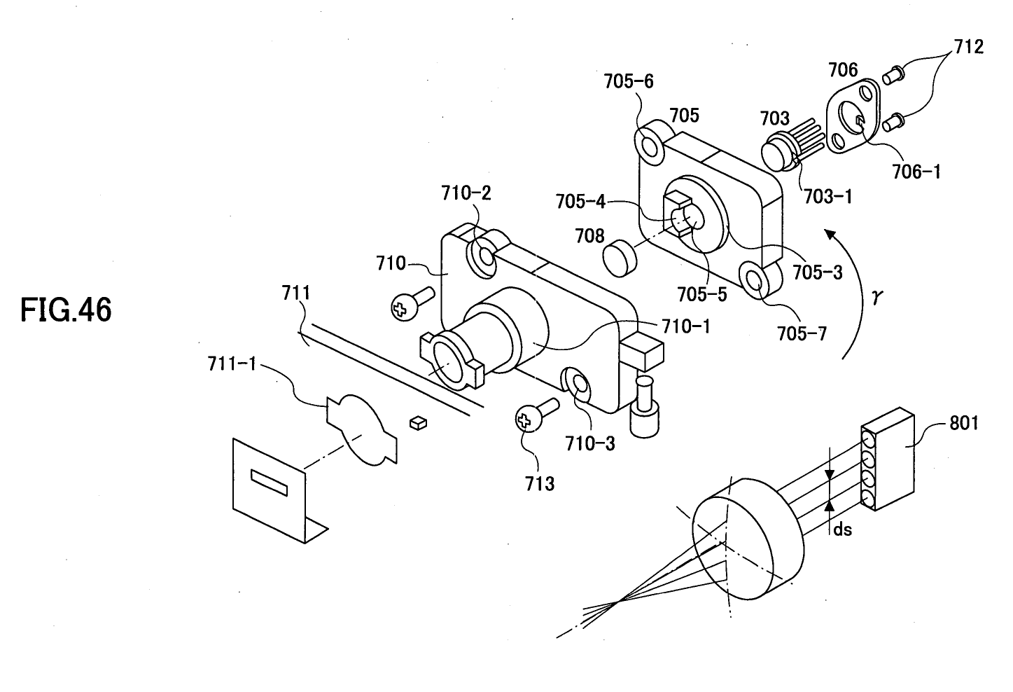

FIG. 46 shows another configuration of the light source unit, where light beams emitted from a semiconductor array having four light sources are combined by means of a beam combining device. A basic configuration thereof is same as that shown in FIG. 45, and description thereof is omitted.

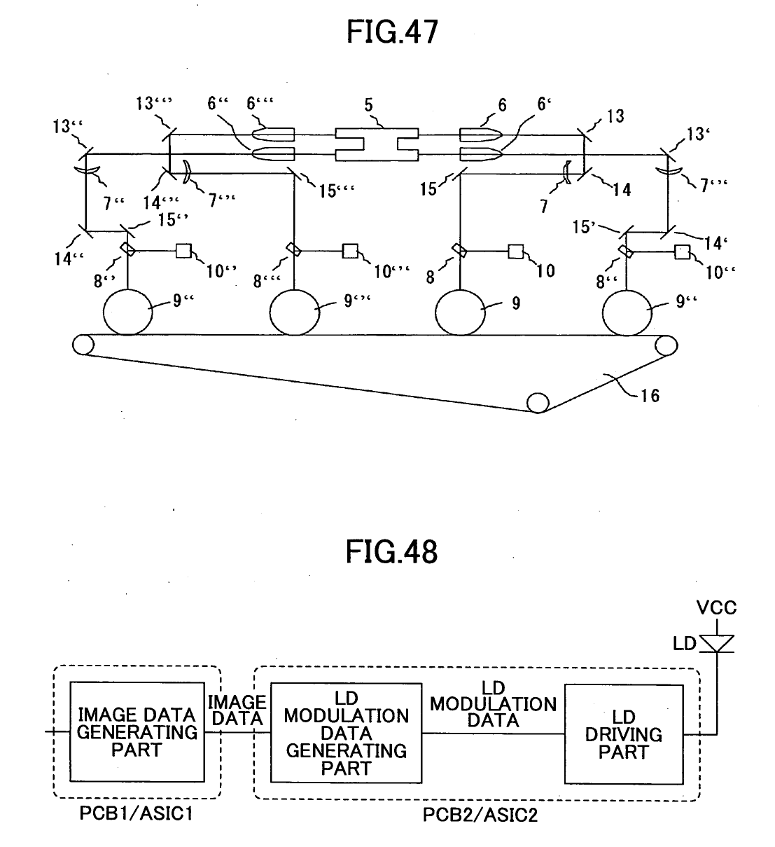

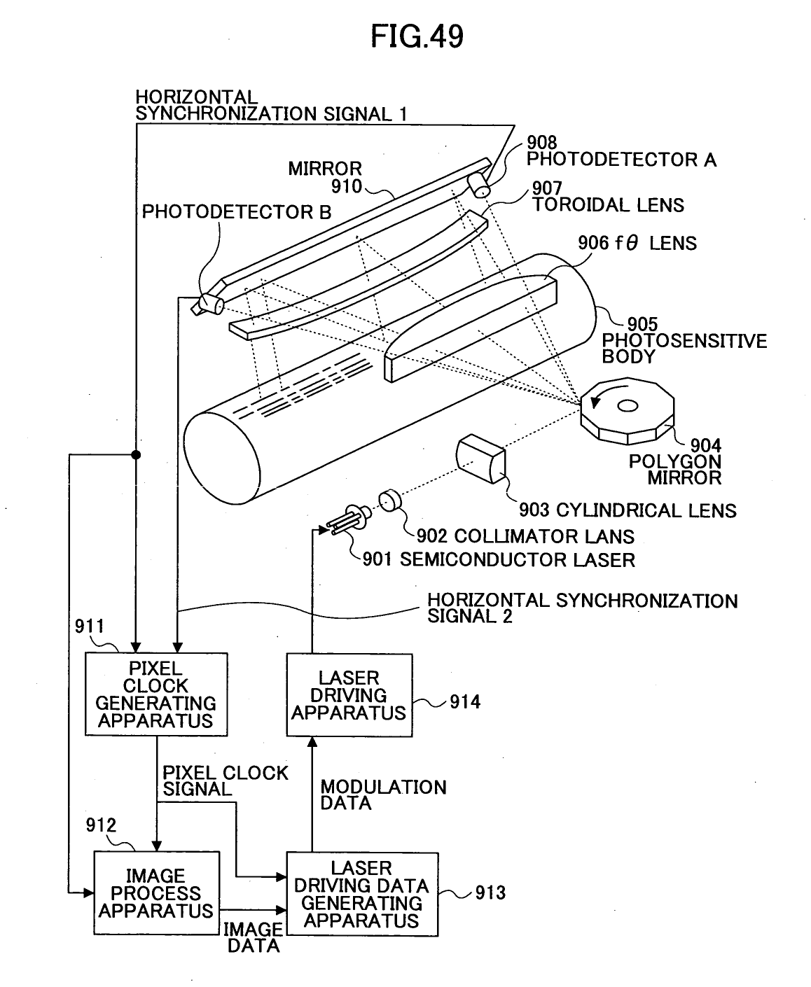

FIG. 47 shows an example in which the present invention is applied to a tandem-type color machine which is an image forming apparatus having a plurality of photosensitive bodies 9. In the tandem-type color machine, the separate photosensitive bodies 9 are provided for respective color components of yellow, magenta, cyan and black, and optical scanning optical system forms respective latent images thereon through separate light paths corresponding to the respective photosensitive bodies 9.

Further, the present invention is not limited to the above-described embodiments, and variations and modifications may be made without departing from the basic concept of the present invention claimed.

The present application is based on Japanese Priority Applications Nos. 2003-329595, filed on Sep. 22, 2003, the entire contents of which are hereby incorporated herein by reference.

1. A color image forming apparatus comprising:
a semiconductor laser;
a semiconductor laser modulation signal generating part generating a signal for modulating said semiconductor laser;
a semiconductor laser driving part driving said semiconductor laser based one the semiconductor laser modulation signal;
a scanning part scanning a photosensitive body with light output by said semiconductor laser; and
a scanning light detecting part detecting the scanning light output by said semiconductor laser at a predetermined position, wherein:
said color image forming apparatus produces a latent image on the photosensitive body based on a signal output from said scanning light detecting part in response to detection of the scanning light;
said semiconductor laser modulation signal generating part comprises a clock generating part and a clock modulation part;
said semiconductor laser and said semiconductor laser driving part are provided for each color of yellow, magenta, cyan and black; and
further, a plurality of the semiconductor lasers are provided for at least one color of yellow, magenta, cyan and black.

2. The color image forming apparatus as claimed in claim 1, wherein:
said semiconductor laser driving part is produced in a form of a single chip.

3. The color image forming apparatus as claimed in claim 1, wherein:
the semiconductor laser driving parts for two or three colors of yellow, magenta, cyan and black are produced in a form of a single chip.

4. The color image forming apparatus as claimed in claim 1, wherein:
the semiconductor laser driving parts for all colors of yellow, magenta, cyan and black are produced in a form of a single chip.

5. The color image forming apparatus as claimed in claim 1, wherein;
the semiconductor laser modulation signal generating part is provided individually for each color of yellow, magenta, cyan and black.

6. The color image forming apparatus as claimed in claim 1, wherein;
the semiconductor laser modulation signal generating part is provided individually for two or three colors of yellow, magenta, cyan and black.

7. The color image forming apparatus as claimed in claim 1, wherein;
the semiconductor laser modulation signal generating part is provided individually for all colors of yellow, magenta, cyan and black.

8. The color image forming apparatus as claimed in claim 1, wherein;
the semiconductor laser modulation signal generating part is produced in a form of single chip for each color of yellow, magenta, cyan and black.

9. The color image forming apparatus as claimed in claim 1, wherein;
the semiconductor laser modulation signal generating part is produced in a form of a single chip for two or three colors of yellow, magenta, cyan and black.

10. The color image forming apparatus as claimed in claim 1, wherein;
the semiconductor laser modulation signal generating part is produced in a form of a single chip for all colors of yellow, magenta, cyan and black.

11. The color image forming apparatus as claimed in claim 1, wherein:
the clock generating part is provided for each color of yellow, magenta, cyan and black.

12. The color image forming apparatus as claimed in claim 1, wherein:
clock signals for all colors of yellow, magenta, cyan and black are generated by two or three clock generating parts.

13. The color image forming apparatus as claimed in claim 1, wherein:
the single clock generating part generates respective clock signals for all colors of yellow, magenta, cyan and black.

14. A semiconductor laser modulation deriving apparatus comprising:
a semiconductor laser;
a semiconductor laser modulation signal generating part generating a semiconductor laser modulation signal for modulating the semiconductor laser; and
a semiconductor laser driving part driving the semiconductor laser based on the semiconductor laser modulation signal, wherein:
said semiconductor laser modulation driving apparatus transmits the semiconductor laser modulation signal from the semiconductor laser modulation signal generating part to the semiconductor laser driving part as a differential signal with a reduced amplitude, and
both an input part in the semiconductor laser driving part and an output part in the semiconductor modulation signal driving part are configured in a CML type.

15. The semiconductor laser modulation driving apparatus as claimed in claim 14, wherein:
a load of the CML circuit is configured by a resistor or a resistance.

16. The semiconductor laser modulation driving apparatus as claimed in claim 14, wherein;
the CML circuit comprises a plurality of stages.

17. The semiconductor laser modulation driving apparatus as claimed in claim 14, wherein;
one input of the CML circuit is provided as a fixed voltage.

18. The semiconductor laser modulation driving apparatus as claimed in claim 14, wherein:
a current source for the CML circuit is configured to comprise a resistor or a resistance.

19. The semiconductor laser modulation driving apparatus as claimed in claim 14, wherein:
a load resistor or a resistance of the CML circuit is provided as an external component.

20. An image forming apparatus comprising:
at least one light source;
a deflecting part deflecting a laser beam emitted from said at least one light source; and
a leading part leading the laser beam deflected by said deflecting part toward a to-be-scanned medium, wherein:
said at least one light source is driven by the semiconductor laser modulation driving apparatus claimed in claim 14.

21. A color image forming apparatus in a tandem type comprising:
at least one light source;
a deflecting part deflecting a laser beam emitted from said at least one light source; and
a leading part leading the laser beam deflected by said deflecting part toward a plurality of to-be-scanned media, wherein:
said image forming apparatus scans said plurality of to-be-scanned media with the laser beams led by said leading part and forms images on the to-be-scanned mediums, respectively; and
said at least one light source is driven by the semiconductor laser modulation driving apparatus claimed in claim 14.

22. A color image forming apparatus comprising:
a semiconductor laser;
a semiconductor laser modulation signal generating part generating a signal for modulating said semiconductor laser;
a semiconductor laser driving part driving said semiconductor laser based one the semiconductor laser modulating signal;
a scanning part scanning a photosensitive body with light output of said semiconductor laser; and
a scanning light detecting part detecting the scanning light output by said semiconductor laser at a predetermined position, wherein:
said color image forming apparatus produces a latent image on the photosensitive body based on a signal output from said scanning light detecting part in response to detection of the scanning light;
said semiconductor laser modulation signal generating part comprises a clock generating part and a clock modulation part;
said semiconductor laser and said semiconductor laser driving part are provided for each color of yellow, magenta, cyan and black;
further, a plurality of the semiconductor lasers are provided for at least one color of yellow, magenta, cyan and black;
the semiconductor laser modulation signal is transmitted from the semiconductor laser modulation signal generating part to the semiconductor laser driving part as a differential signal with a reduced amplitude; and
both an input part in the semiconductor laser driving part and an output part in the semiconductor modulation signal driving part are configured in a CML type.

23. The color image forming apparatus as claimed in claim 22, wherein;
the semiconductor laser modulation signal generating part is provided individually for each color of yellow, magenta, cyan and black.

24. The color image forming apparatus as claimed in claim 22, wherein;
the semiconductor laser modulation signal generating part is provided individually for two or three colors of yellow, magenta, cyan and black.

25. The color image forming apparatus as claimed in claim 22, wherein;
the semiconductor laser modulation signal generating part is provided individually for all colors of yellow, magenta, cyan and black.

26. The color image forming apparatus as claimed in claim 22, wherein;
the semiconductor laser modulation signal generating part is produced in a form of a single chip for each color of yellow, magenta, cyan and black.

27. The color image forming apparatus as claimed in claim 22, wherein;
the semiconductor laser modulation signal generating part is produced in a form of a single chip for two or three colors of yellow, magenta, cyan and black.

28. The color image forming apparatus as claimed in claim 22, wherein;
the semiconductor laser modulation signal generating part is produced in a form of a single chip for all colors of yellow, magenta, cyan and black.
